(19) United States
(12) Patent Application Publication
(10) Pub. No.: US 2005/0044067 A1
(43) Pub. Date: Feb. 24, 2005

(54) Collection processing system

(76) Inventor: Kevin Wade Jameson, Calgary (CA)

Correspondence Address: KEVIN JAMESON, 148 EDGEBANK PLACE NW, CALGARY, AB, T3A 4L4, CA

(21) Appl. No.: 10/645,550

(22) Filed: Aug. 22, 2003

(51) Int. Cl. G06F 7/00

(52) U.S. Cl. 707/3

(57) ABSTRACT

A Collection Processing System enables people to perform complex computational operations on large sets of collections, using a simple and convenient syntax for collection symbolic job requests. A collection symbolic job request is comprised of a user-defined symbolic task name, and a collection reference expression that can refer to large sets of collections. Collections are data-typed sets of computer files that can be manipulated as a set, rather than as individual files. In operation, a Collection Processing System receives a collection symbolic job request from a request originator, and expands the symbolic job request into a list of executable commands that carry out the computational intent of the symbolic job request. First-level symbolic task names are expanded into sequences of second-level task part statements, and then into third-level executable computer commands that are dynamically generated into customized, optimal makefiles. Collection reference expressions are expanded into lists of job triplets comprised of a particular collection name, a computing platform name, and a processing dependency visit order value. The present invention applies third-level executable commands to job triplets to carry out the original collection symbolic job request, in a distributed, multiplatform, scalable way that was not previously known to the art.

### RELATED APPLICATIONS

The present inventive application builds on several inventive principles that are disclosed in previous applications, by using those inventive principles as a foundation for the inventive method and data structures disclosed in the present application.

This application is related to U.S. patent application Ser. No. 09/885,078, filed Jun. 21, 2001, by Kevin W Jameson, titled “Collection Information Manager,” which discloses an inventive method and structure for delivering collection information to application programs. “Collections”—a special lexicographic term—are inventive data structures that enable the inventive methods and structures in this series of inventions.

This application is related to U.S. patent application Ser. No. 09/885,080 filed Jun. 21, 2001 by Kevin W Jameson, titled “Collection Recognizer,” which discloses an inventive method and structure for recognizing and selecting collections stored in computer file systems.

This application is related to U.S. patent application Ser. No. 09/885,077 filed Jun. 21, 2001 by Kevin W Jameson, titled “Collection Makefile Generator,” which discloses an inventive method and structure for delivering expanded collection references to programs, and which is incorporated herein by reference.

This application is related to U.S. patent application Ser. No. 09/885,079, filed Jun. 21, 2001 by Kevin W Jameson, titled “Collection Knowledge System,” which discloses an inventive method and structure for delivering context-sensitive knowledge to application programs, and which is incorporated herein by reference.

This application is related to U.S. patent application Ser. No. 10/227,848, filed Aug. 27, 2002 by Kevin W Jameson, titled “Collection Storage System,” which discloses an inventive method and structure for managing the storage and evolution of collections by performing collection storage operations on collections and collection views, and which is incorporated herein by reference.

This application is related to U.S. patent application Ser. No. 10/227,822, filed Aug. 27, 2002 by Kevin W Jameson, titled “Collection Shortcut Expander,” which discloses an inventive method and structure for delivering expanded collection references to programs, and which is incorporated herein by reference.

This application is related to U.S. patent application Ser. No. Unassigned, filed contemporaneously herewith by Kevin W Jameson, titled “Collection Symbolic Job Expander,” which discloses an inventive method and structure for enabling people to use convenient symbolic job requests to perform operations on large sets of collections without having to provide low-level processing details associated with the job request, and which is filed contemporaneously herewith and incorporated herein by reference.

### FIELD OF INVENTION

This invention relates to computer software programs for processing collections of computer files in arbitrary ways, thereby increasing the productivity of software developers and other knowledge workers that routinely work with collections of computer files. Collections are data-typed trees of computer files that can be manipulated as a set, rather than as individual files.

### BACKGROUND OF THE INVENTION

Terminology

This application uses special terminology and associated lexicographic meanings to clearly define the inventive concepts and structures of the present invention.

Readers should be careful not to confuse the intended meanings of special terms such as “collection” in this application with the common dictionary meanings of these words. In particular, much novel and inventive structure is introduced into the claims by including these special terms in claim clauses that narrow and limit the claims.

The term “collection” herein normally refers to a tree of computer files that can be manipulated as an integrated, recognizable, data-typed set, rather than as individual computer files. Collections—unlike normal file system folders—have a defined structure, contain a collection specifier file, and contain a collection data type indicator that links to a collection type definition. Collections are manipulated according to data handling policies that are defined in a collection type definition, and may contain optional collection content that is recognized and manipulated according to policies defined in a collection type definition. Formally, the term “collection” refers to an inventive data structure that is the union of collection specifier information and collection content information.

The term “collection specifier” refers to an inventive data structure that contains information about a collection instance. For example, collection specifiers may define such things as a collection type, a text summary description of the collection, collection content members, derivable output products, collection processing information such as processing parallelism limits, special collection processing steps, and program option overrides for programs that manipulate collections. Collection specifiers are typically implemented as simple key-value pairs in text files or database tables.

The term “collection type definition” refers to an inventive data structure that contains user-defined sets of attributes that can be shared among multiple collections. Collection type definitions typically define such things as collection types, product types, file types, action types, administrative policy preferences, and other information that is useful to application programs for understanding and processing collections of a particular collection type.

The term “collection information” refers to an inventive data structure that is the union of collection specifier information, collection type definition information, and collection content information. Collection information is what application programs need to know in order to “understand” and process collections in a smart way, in accordance with local site policies.

The term “collection symbolic job request” refers to an inventive data structure that is comprised of a symbolic task name and a collection reference expression.

The term “symbolic task name” refers to a user-defined token that can be expanded into a sequence of executable computer commands that can be used to process a collection to fulfill the intent of a collection symbolic job request.

The term “collection reference expression” refers to a sequence of characters that refers to one or more collections within a managed collection namespace.

The term “collection processing operation” refers to a computational operation performed by a collection processing system on a collection, to fulfill the functional intent of a collection symbolic job request.

Background

The present invention addresses the general problem of low productivity among human knowledge workers who use tedious manual procedures to work with groups of computer files. The most promising strategy for solving this productivity problem is to build automated computer systems to replace manual human effort.

One new software technology for improving productivity—software collections—enables people and computer programs to process collections of computer files more productively than previously possible. Collections are normal directory structures (“file folders”) of normal computer files, but they contain a special collection specifier file in the root directory of the collection. Collection specifier files are designed to be parsed by computers, and specify, among many other things, data types for collections. Computer programs can use collection data type values as lookup keys into databases containing collection type definitions, to obtain detailed information about known collection data types. Detailed information from collection type definitions enables computer programs to better understand the structure and content of collections that are being processed. Having access to detailed information about collections enables computer programs to process collections in more intelligent ways than were previously possible

Collections are useful and practical because they make it easier for computer programs to manipulate the contents of collections in useful ways. In one typical scenario, users invoke computer programs within a working directory contained within a collection directory tree structure. Computer programs recognize the location of a current collection by searching upwards for a special collection specifier file. Once programs know the physical location—the root directory—of a current collection, they can obtain corresponding collection type information for the collection, and then manipulate the collection in intelligent ways to fulfill their processing functions.

Although collections are useful and practical for representing collections of computer files, no scalable computer systems exist for processing either individual collections or large sets of collections in convenient ways. This is a significant practical limitation, because scalable collection processing systems could significantly increase the productivity of people who routinely work with collections. In particular, a scalable, multiplatform collection processing system would greatly improve the productivity of software developers who perform distributed multiplatform software builds that involve large numbers of software files.

Need for a Collection Processing System

An ideal collection processing system would accept simple, convenient, and high-level collection processing commands (symbolic job requests) from people, and would perform the requested job operations automatically, without requiring any further detailed processing information from the people who submitted the job request

People could thereby perform complex processing tasks on large numbers of collections without having to remember, or specify, tedious processing details such as long lists of specific collection names, which computing platforms should be used to process each collection in a set, or long lists of processing dependency relationships that might exist between individual collections within a set of collections that is being processed.

The Present Collection Processing System Invention

The present Collection Processing System invention contemplates inventive data structures and a method for automatically calculating and executing arbitrary, user-defined computational tasks on large sets of collections. (Collection information is a term that refers to the union of collection specifier information, collection type definition information, and collection content information.)

In particular, the present Collection Processing System invention solves the problem of automatically calculating and applying complex, user-defined computational tasks to large sets of collections, in a scalable, distributed, multiplatform, context-sensitive way, with no human labor involved.

Practical Applications in the Technical Arts

The present Collection Processing System invention contemplates a method for using collection information to automatically calculate and execute arbitrary computational tasks on large sets of collections. (Collection information is a term that refers to the union of collection specifier information, collection type definition information, and collection content information. Collection type definition is typically stored in a central knowledge base that can be shared by multiple collections and application programs.)

One notable practical application in the technical arts of the present Collection Processing System invention is in the field of distributed multiplatform software builds. The present invention is capable of calculating and executing complex and distributed, multiplatform software builds automatically, using only a simple command line invocation, with no other significant human labor required. The benefit of being able to perform large, complex software builds using no human labor is a significant step forward in productivity for the software industry, and has not been possible using prior art techniques.

A second practical application in the technical arts of the present Collection Processing System invention is to perform arbitrary, user-defined computational operations on sets of collections. For example, a Collection Processing System can be configured to build websites from collections containing website information, to install software applications from collections containing software applications and installation information, or to print documents from collections containing document information.

To a first approximation, for any computational process that can be carried out by calling a sequence of non-interactive, command-line programs, the present Collection Processing System can be configured to dynamically calculate and carry out instances of the same computational process. Each calculated computational process instance is precisely customized for the particular collections and computational processes that are being used in the computation, permitting fine-grained customizations and special case operations for particular operations and individual collections.

Many other practical applications of the present invention are also possible. Those skilled in the art can see that the present Collection Processing System invention is practical and useful in a large number of computer processing applications, wherever people could benefit from having an automated system calculate and carry out custom computational processes on collections.

Subproblems to Solve

The overall collection processing system problem is complex, so it is useful to divide the overall problem into smaller subproblems that are easier to understand. The following paragraphs characterize several of those subproblems.

The Collection Processing System Problem is the overall problem to solve. It is the problem of how to calculate and execute a computational process on a collection reference expression, in a scalable, automated, multiplatform, and context-sensitive way. Solving this problem will enable people and programs to use detailed collection information to perform large-scale collection processing tasks that are not possible using prior art techniques.

The Collection Processing System Problem has at least the following interesting aspects: an arbitrary number of user-defined collections, collection views, collection types, and collection processing tasks may be involved; an arbitrary number of computing platforms and collection execution machines may be involved; and collection processing tasks may depend on collection types, computing platforms, or user-defined processing contexts.

The Collection Job Expansion Problem is another problem to solve. It is the problem of how to calculate a complete list of collections to process from a single collection reference expression provided on a command line. Solving this problem will enable people to conveniently reference and process large sets of collections as easily as they can process individual collections.

The Collection Job Expansion Problem has at least the following interesting aspects: a collection reference expression can indirectly reference arbitrary numbers of collections, collection views, and collection groups, recursively. In addition, job expansion calculations require the use of collection information.

The Collection Platform Assignment Problem is another problem to solve. It is the problem of how to calculate a list of computing platforms on which to process a particular collection in a multiplatform computing environment. Since each collection in a set of collections may require processing on a different set of computing platforms, solving this problem will enable people to request large collection job processing jobs without being responsible for providing low-level platform assignment details.

The Collection Platform Assignment Problem has at least the following interesting aspects: a platform assignment list can contain multiple platforms for one collection; a collection can be processed on individual or multiple computing platforms, sequentially or simultaneously; lists of appropriate computing platforms for collections are context-sensitive; lists of appropriate computing platforms are dependent on collection type and collection build type; and users can specify particular, user-defined platform assignments as part of collection job requests.

The Collection Job Ordering Problem is another problem to solve. It is the problem of how to calculate and properly schedule processing dependencies among multiple collections, so that collections are processed (visited) in proper dependency order. Solving this problem will enable people to perform complex processing tasks on large sets of collections without being responsible for understanding and controlling processing dependencies among individual collections within a set of collections.

The Collection Job Ordering Problem has at least the following interesting aspects: arbitrary numbers of collections may be involved; arbitrary user-defined collection types may be involved; processing dependencies may vary with collection type; and collection information may not be available to the originator of the collection processing request.

The Collection Job Scheduling Problem is another problem to solve. It is the problem of how to schedule and manage the simultaneous execution of multiple collection processing jobs in a distributed, multiplatform collection processing system. Solving this problem will enable people to perform complex processing tasks on large sets of collections without having to consider any job scheduling details.

The Collection Job Scheduling Problem has the following interesting aspects: a job scheduler may have to manage hundreds of job execution computers that vary by computing platform, hardware performance, or other execution attributes, and requested computing job attributes must be matched to execution computer attributes; job dependencies must be maintained when processing jobs in parallel on one or more execution computers; and schedulers must allow for the effects of failed jobs and failed execution computers on overall job streams.

The Collection Process Execution Problem is another problem to solve. It is the problem of how to calculate and execute optimal computational processes for processing collections in context-sensitive ways. Solving this problem will enable people to perform complex processing tasks on collections, on arbitrary distributed computer platforms, without having to provide detailed, low-level execution information in the job request. That is, people can perform large-scale computational operations on large numbers of collections simply by providing collection reference expressions and processing task names on a command line. A collection processing system dynamically determines all remaining execution details.

The Collection Process Execution Problem has at least the following interesting aspects: multiple collections, collection types, and collection views may be involved; multiple computing platforms may be involved; arbitrary user-defined processing tasks and collection types may be involved; multiple dependencies among computational tasks may be involved; and multiple different context-sensitive computational environments may be involved.

The Platform Dependent Processing Task Problem is another problem to solve. It is the problem of how to represent platform-dependent processing tasks so that people can specialize the implementation of processing tasks for various computing platforms. Solving this problem will enable people to issue symbolic job requests on multiple platforms, to perform the same conceptual processing task, without having to be concerned with the different executable programs and process steps that are required to carry out the job request on various computing platforms.

The Platform Dependent Task Problem has at least these interesting aspects: both overall processes and individual processing tasks can be specialized by computing platform; platforms can be user-defined; platforms can use different computational programs and different command sequences to accomplish the same conceptual processing goals; an arbitrary number of user-defined computing platforms may be involved.

General Shortcomings of the Prior Art

A search of the prior art found no disclosures that cited information close enough to the present invention to be worth referencing. A USPTO patent examiner specifically requested that irrelevant material NOT be included for the sole purpose of citing some prior art in the present application. Since I could find no RELEVANT prior art that worked with large numbers of collections, dynamically calculated computational processes, used a network of heterogeneous computers, and used no human labor, no such prior art is listed herein.

The prior art contains no references that are relevant to the present invention. In particular, the prior art does not discuss collections, nor does it discuss scalable, automated collection processing systems. Accordingly, the following discussion is general in nature, because there are no relevant specific works of prior art to discuss.

Prior art approaches, including prior art software build systems, lack support for collections, and by extension, for collection information. This is the largest limitation of all in the prior art, because it prevents people and programs from using high-level collection abstractions that can significantly improve productivity.

Prior art approaches lack support for collection references. This limitation prevents people from conveniently referencing large sets of collections, collection views, and collection groups with a simple command line reference expression.

Prior art approaches lack support for user-defined, platform-dependent processing task definitions that specify platform-dependent processing policies for whole classes of computations. This limitation prevents people from conveniently creating, applying, and reusing stored platform-dependent collection processing policies for multiple computations.

Prior art approaches lack support for calculating and enforcing execution order dependencies (visit orders) among large numbers of collection processing tasks, especially in the context of distributed, multiplatform collection processing systems.

Prior art approaches lack support for dynamically calculating and executing collection-oriented executable process descriptions. Examples of executable process descriptions include makefiles, shell scripts, batch files, and other (usually script language) executable descriptions. This limitation forces people to manually create and maintain executable process descriptions using significant amounts of human labor.

As can be seen from the above descriptions, prior art approaches lack the means to make it easy—or even possible—for people to conveniently perform complex processing tasks on large sets of collections, collection views, and collection groups. Prior art approaches lack practical means for modelling collections, collection processing tasks, collection processing dependencies, collection processing contexts, platform dependent processing information, and collection process executions. Prior art approaches also especially lack the means for dynamic calculation of context-sensitive, platform-dependent executable process descriptions, with no human labor involved.

In contrast, the present invention has none of these limitations, as the following disclosure will show.

### SUMMARY OF THE INVENTION

Collection Processing Systems improve the productivity of knowledge workers in the information industry by performing fully automated, complex, user-defined processing tasks on large sets of collections using scalable, distributed, multiplatform computing methods. In particular, the present Collection Processing System invention is capable of performing complex and distributed, multiplatform software builds using networks of heterogeneous computers, with essentially no human labor involved.

A Collection Processing System is primarily comprised of software clients, a central scheduling server, and one more job execution servers. Depending on implementation architecture, a Collection Processing System may also embody important operational functions such as collection job expansion, collection view expansion, and collection makefile generation in standalone programs that support the architecture and functions of a collection processing system. Collection processing system software modules are distributed among multiple heterogeneous computing platforms.

In operation, client programs obtain collection-processing requests from people or programs, and forward the job processing requests to a central scheduling server. A central scheduling server first expands the original processing request (which may reference multiple collections and job tasks) into a list of individual, platform-dependent, collection-platform-order triplets (actually, quadruplets, if the original symbolic task name is also included). The list of job triplets represents the total computation implied by the original processing request.

The central scheduler repetitively assigns individual triplets to appropriate execution servers for execution, using the task name from the original request in each assignment. The scheduler considers and manages all scheduling details, such as managing appropriate dependency orderings among triplets, and matching triplet attributes (such as required computing platform and hardware capabilities) with assigned execution servers. Results of individual job triplet executions are returned to the request originator.

Execution servers receive a job quadruplet from a central scheduler. Job quadruplets are comprised of a collection reference (a collection to work on), a processing task name (a computation to perform), a platform assignment, and a visit order value. Execution servers proceed by (1) obtaining referenced collections from remote collection storage systems or equivalents, (2) dynamically calculating an executable process description such as a makefile, precisely optimized for the particular job triplet and execution server at hand, and finally (3) executing the calculated process description according to the job triplet parameters. Job execution status information is passed back to the central scheduler for reporting purposes.

Collection Processing Systems enable people to perform complex processing tasks on large sets of collections without having to manage tedious job processing details such as ordering dependencies, platform dependencies, job expansion details, or platform assignment details. By using detailed collection information and job processing policies stored in a central knowledge base, collection processing systems can perform collection processing tasks that were not previously possible using prior art techniques.

### OBJECTS AND ADVANTAGES

The main object of the present Collection Processing System invention is to improve the productivity of human knowledge workers by enabling them to perform complex processing tasks on large sets of collections in a scalable, distributed, multiplatform way, using essentially no human labor.

Another object is to solve the Collection Processing System Problem by providing inventive means for calculating and executing a computational process on a collection reference expression, in a scalable, automated, multiplatform, and context-sensitive way

Another object is to solve the Collection Job Expansion Problem by providing inventive means for dynamically calculating a complete list of collections to process from a single collection reference expression provided on a command line.

Another object is to solve the Collection Platform Assignment Problem by providing inventive means for dynamically calculating a list of computing platforms on which to process particular collections.

Another object is to solve the Collection Job Ordering Problem by providing inventive means for dynamically calculating and properly scheduling processing dependencies among multiple collections and multiple computing platforms.

Another object is to solve the Collection Job Scheduling Problem by providing inventive means for scheduling and managing the simultaneous execution of multiple collection processing jobs in a distributed, multiplatform collection processing system

Another object is to solve the Collection Process Execution Problem by providing inventive means for dynamically calculating and executing optimal computational processes for processing collections in a context-sensitive way.

Another object is to solve the Platform Dependent Processing Task Problem by providing means for representing and performing platform dependent processing tasks, thereby enabling people to specify and execute platform-dependent task implementations for different computing platforms.

As can be seen from the objects that are listed above, Collection Processing Systems provide many useful and practical services to people and computer programs that work with collections.

Further advantages of the present Collection Storage System invention will become apparent from the drawings and disclosures that follow.

### BRIEF DESCRIPTION OF DRAWINGS

The following paragraphs introduce the drawings.

FIG. 1 shows a sample prior art file system folder from a typical personal computer.

FIG. 2 shows how a portion of the prior art folder in FIG. 1 has been converted into a collection 100 by the addition of a collection specifier file 102 named “collspec” FIG. 2 Line 5.

FIG. 3 shows the contents of a collection specifier file 102, implemented with a simple text file from a typical personal computer system.

FIG. 4 shows a filesystem tree containing several collections, located at various hierarchical levels (depths) within a filesystem tree.

FIG. 5 shows a list of pathnames that show the filesystem locations of the collections in the tree of FIG. 4.

FIG. 6 shows a prior art configuration management system that does not understand collections.

FIG. 7 shows a Collection Storage System (CSS) that understands collections, and that is capable of performing collection-aware operations.

FIG. 8 shows the structure of a complete collection reference.

FIG. 9 shows an example collection reference that is a normal “whole collection” reference for the collection shown in FIG. 2.

FIG. 10 shows a table of shortcut collection references and their meanings.

FIG. 11 shows the structure of a collection symbolic job request.

FIG. 12 shows two example collection symbolic job requests.

FIG. 13 shows the results of a collection reference name expansion.

FIG. 14 shows the results of a visit order expansion.

FIG. 15 shows a list of four computing platforms.

FIG. 16 shows a list of one computer platform, this time for a different collection.

FIG. 17 shows the results of a collection reference, a visit order, and a platform expansion for a single collection “cf-colls:mysite.com:c-myprogram.”

FIG. 18 shows the results of a collection reference, visit order, and platform expansion for a single collection “cf-colls:mysite.com:c-myhomepage.”

FIG. 19 shows the results of a collection reference, a visit order, and a platform expansion for the original symbolic job request of FIG. 12 and FIG. 13.

FIG. 20 shows an inventive data structure for holding collection symbolic job expansion information.

FIG. 21 shows a simplified architecture for a CPS system.

FIG. 22 shows a simplified algorithm for the CPS system of FIG. 21.

FIG. 23 shows a simplified architecture of a CPS system that shows several more subordinate modules that help CPS Queue Manager Means 141 to perform its primary functions.

FIG. 24 shows a simplified algorithm for the CPS system architecture of FIG. 23.

FIG. 25 shows a simplified architecture for a CPS Execution Server Means 160.

FIG. 26 shows a simplified algorithm for a CPS Execution Server Means 160.

FIG. 27 shows a simplified architecture for a preferred CPS system that performs symbolic job expansion using an external support program.

FIG. 28 shows a simplified algorithm for the CPS system of FIG. 27.

FIG. 29 shows a simplified architecture for a CPS Execution Server Means 160 that performs symbolic job expansion by calling an external support program module CPS Execution Job Expansion Means 162.

FIG. 30 shows a simplified algorithm for the CPS Execution Server Means 160 of FIG. 29.

FIG. 31 shows the syntax of a task definition file.

FIG. 32 shows a simplified symbolic task name table.

FIG. 33 shows an example task definition file for the “rebuild” symbolic task name.

FIG. 34 shows a table of variables used by a CPS Execution Server Means 160.

FIG. 35 shows an example of variable values for a “win2000” computing platform.

FIG. 36 shows an example of variable values for a “linux2” computing platform.

FIG. 37 shows an example task part name table.

FIG. 38 shows an example task part definition file for a checkout operation.

FIG. 39 shows an example task part definition file for generating a makefile.

FIG. 40 shows an example task part definition file for building a C program collection.

### LIST OF DRAWING REFERENCE NUMBERS

100 A collection formed from a prior art file folder
102 A collection specifier file
110 A Configuration Management System Client
111 A Configuration Management System Server
112 A Do Non-Collection Operations Means
113 Local copies of authoritative files
114 Authoritative files in a CM repository
115 A Collection Storage System Client Means
116 A Collection Storage System Server Means
117 A Collection Storage Operation Manager Means
118 Local copies of authoritative collections
119 Authoritative collections in a CSS repository
124 A Collection Storage System Means
125 A Collection Knowledge System Means
140 A CPS Client Means
141 A CPS Queue Manager Means
142 A CPS Job Dispatcher Means
143 A CPS Job Reporter Means
150 A CPS Symbolic Job Expander Means
160 A CPS Execution Server Means
161 A CPS Executable Process Execution Means
162 A CPS Execution Server Job Expansion Means
163 A CPS Executable Process Calculation Means

### DETAILED DESCRIPTION

The following disclosure describes the present Collection Processing System invention with reference to a preferred file system implementation of the invention. However, the invention is not limited to any particular computer architecture, operating system, file system, database, or other software implementation. The descriptions that follow should be considered as implementation examples only and not as limitations of the invention.

Introduction to Collection Processing Systems

The following several sections introduce the present Collection Processing System by describing a major design goal and several major functional needs that motivate the architecture of a preferred implementation that is described in this document.

After readers have gained a first understanding of the overall system, further implementation details are presented in subsequent sections.

Design Goals for a Collection Processing System

The main design goal of the present invention is to make it easy for people to process computer files by issuing a command like “System, do this (task) to that (collection).”

For example, a person might want to say “Rebuild my software application on the usual 20 computing platforms,” or “Export my updated website to the web server,” or “I just made some changes in my program code. Rerun my usual matrix of 100 data sets against the new changes in my scientific modelling and analysis program.”

Those skilled in the art can see that these examples are in a “do this to that” format that hides an enormous amount of complex, multiplatform implementation detail. Accordingly, it is a design goal of a collection processing system that people issuing such commands to a collection processing system do not have to specify any low level details. Instead, a collection processing system should dynamically calculate all low-level processing details that are required to carry out the request, with no significant human labor involved.

The following sections discuss several major functional needs of a CPS system:
1. Need for representing “do this”—symbolic task names
2. Need for representing “to that”—collections
3. Need for distributed collection access—collection storage system
4. Need for multiple collections and platforms—collection job expander
5. Need for dynamic executable process calculation—makefile generator
6. Need for stored knowledge—collection knowledge system
   Need for Representing “Do This”—Symbolic Task Names

An ideal collection processing system (CPS) syntax would allow people to say, “Collection Processing System, do this to that,” where “do this” means “perform this symbolic task name.” This syntax is very simple, is easy to remember, and can be used by everyone from novices to experts to carry out complex computer processing tasks.

In order to implement a “do this to that” syntax design goal, a CPS system must provide a means for representing, calculating, generating, and carrying out executable command sequences that correspond to a symbolic task name (“do this”) in a CPS job request command line.

The present invention provides such means. It enables users to define their own symbolic task names to suit their processing needs. It also enables users to define their own executable task part fragments, to carry out small “building block” subtasks that can be part of a larger computation. A CPS system uses task parts to dynamically calculate, generate, and execute computational processes specified by symbolic task names.

In a preferred implementation described later in this document, symbolic tasks are comprised of symbolic task name tables, symbolic task name definition files, task parts, and task part options. Task part options specify limitations such as “perform this task on all platforms in the job request,” or “perform this task once, on only one of the platforms in the job request.” This approach provides people with a great deal of flexibility in how symbolic tasks are defined, calculated, and executed.

Need for Representing “To That”—Collections

An ideal collection processing system (CPS) syntax would allow people to say, “Collection Processing System, do this to that,” where “to that” means “to this set of collections.”

In order to implement a “do this to that” design goal, a CPS system must provide a means for representing large sets of collections using a simple collection referencing syntax that can be easily used on a CPS job request command line.

The present invention provides such means in the form of collection reference expressions, which can reference both individual collections and sets of collections for processing. Collection reference expressions are used to reference collections that are stored in a Collection Storage System that is accessible to a CPS system.

Need for Distributed Collection Access—Collection Storage System

In order for a Collection Processing System (CPS) to work on individual collections or large sets of collections, there must be a way for a CPS system to access the collections of interest.

A Collection Storage System (CSS) fulfills this need. A CSS system is similar to a prior art configuration management system, except that a CSS system understands inventive collection data structures and associated inventive methods for performing collection-aware operations.

Collection storage systems that understand collections and collection-oriented operations have a significant practical advantage over prior art configuration management systems because CSS systems are functionally more useful to people and programs that work with collections. Prior art configuration management systems, since they do not understand collections, cannot fulfill the collection access requirements and collection-processing requirements of collection processing systems.

Collection storage systems, in addition to providing the usual configuration management operations familiar to those skilled in the art, also manage a namespace for collections, thereby enabling people to reference individual collections or sets of collections using a convenient, collection-oriented syntax that is defined by the storage system.

Collection processing systems use CSS systems to access collections and to obtain associated collection information that is stored within the CSS system.

See the list of related patent applications at the front of this document for more information on a preferred implementation of a Collection Storage System.

Need for Multiple Collections and Platforms—Collection Job Expander

When people process large sets of collections on multiple computing platforms using a simple “do this to that” syntax, a CPS system must provide means for expanding the simple syntax into a set of smaller, non-symbolic jobs that can actually be executed by a CPS system.

In particular, the “do that” part must be expanded into a list of specific individual collections. CPS systems must provide for processing dependencies among collections on the list. CPS systems must determine or assign computer platforms to individual collections that must be processed. (Individual collections may require processing on multiple platforms.)

A Collection Symbolic Job Expander provides means to expand collection references, to determine a proper dependency processing ordering among individual collections, and means to identify a set of computing platforms on which to process individual collections.

A job expander carries over the original symbolic task name “do this” to all collections on the list of expanded collections. This is because a Collection Symbolic Job Expander merely expands the convenient “do this to that” job syntax into a long list of individual job requests (job quadruplets) that each specify a task, collection name, computing platform, and dependency processing order. A Collection Job Expander does not actually execute job requests.

Since the original task name is the same for all expanded jobs, it is convenient to ignore the task name, and focus on the remaining three pieces of unique information (collection, platform, visit order). Accordingly, the terms “job quadruplets” and “job triplets” can be used interchangeably within this document.

CPS systems use job expanders to expand incoming “do this to that” symbolic job requests into lists of expanded job requests that can actually be executed by the CPS system.

From an implementation point of view, collection job expansion duties can be performed either “in-house” by the CPS system itself, or can be “out-sourced” to an external, subordinate auxiliary program that is called by the CPS system when necessary. A preferred implementation of the present CPS invention out-sources job expansion to an external Collection Symbolic Job Expander program.

See the list of related patent applications at the front of this document for more information on a preferred implementation of a Collection Symbolic Job Expander.

Need for Dynamic Executable Process Calculation—Makefile Generator

When a CPS system receives an incoming “do this to that” symbolic job request, it performs a job expansion action to obtain a list of expanded job requests that involve specific individual collections, computing platforms, and dependency processing orders.

Next, the CPS system dispatches the expanded job requests to various distributed CPS execution servers to carry out the requested symbolic task “do this” on an individual collection.

At this point, the CPS system must expand the symbolic task name “do this” into a sequence of command lines that can be executed to carry out the requested symbolic computation.

The CPS system itself does not usually model or implement makefiles or scripting language files to carry out second level computation commands.

Instead, a preferred implementation of a CPS system typically calls an external makefile generator program to perform the (very) complex task of modeling, calculating, and generating customized, optimal, multiplatform, parallel makefiles to carry out the primary computations intended by the original “do this to that” symbolic job request.

See the list of related patent applications at the front of this document for more information on a preferred implementation of a Collection Makefile Generator.

Need For Stored Knowledge—Collection Knowledge System

Those skilled in the art will recognize that a large amount of information is required to carry out the functions and responsibilities of a CPS system as described above. For example, information is required to model at least symbolic job requests, job expansion actions, collections, dependency orderings among collections, computational processes for collections, computing platforms, symbolic tasks, task parts, prologue and epilogue commands, and makefile generation and execution information.

A Collection Knowledge System can be used to model, manage, and provide the large amount of information required by a CPS system and its supporting external programs (e.g. collection storage system, job expander program, makefile generator program).

See the list of related patent applications at the front of this document for more information on a preferred implementation of a Collection Knowledge System.

Overview of a Collection Processing System

Now that readers have an understanding of the main design goal and of the main functional needs of a Collection Processing System, we can tie these introductory concepts together in a typical (but simplistic) execution scenario.

The main point of this scenario is to help readers to tie together the high-level concepts presented so far into a “big picture” or “framework” understanding of the present CPS invention, before readers have to understand the low-level implementation details that make the system work.

In operation, a CPS client receives a “do this to that” symbolic job request command, and passes the symbolic job request command to a CPS central scheduler.

A CPS scheduler module performs a job expansion action on the symbolic job request to obtain an expanded list of less-symbolic job request “triplets” that specify particular collection names, computing platforms, and dependency processing orders. All jobs on the expanded list also contain the original “do this” symbolic task name, which makes them “quadruplets,” to be precise. But since all symbolic task names are identical, much of this document ignores the identical task names and focuses on “job triplets” instead.

Next, the CPS scheduler dispatches individual job triplet requests to CPS execution servers, taking care to maintain proper dependency processing orders among expanded job requests, and to match job requests with appropriate computing platforms. For example, some job triplets might require a fast computer, or a computer with a specific user-defined platform name such as “linux2” or “win2000.” (These platform names are not trademarked names; they are user-defined names.)

As part of the dispatching action, the CPS scheduler performs a task name expansion of the first-level symbolic “do this” task name into a sequence of second-level prologue, main, and epilogue processing commands. The CPS scheduler issues these second-level commands to a CPS execution server, one at a time. A typical second-level command sequence, familiar to software developers who are skilled in the programming arts, might be “checkout my-collection,” “generate makefile,” “make all,” “make install,” and “delete my-collection.”

CPS execution servers on various computing platforms receive, expand, and execute, second-level commands issued by the CPS scheduler. For example, a CPS scheduler might issue a second-level command to a CPS execution server to “generate a makefile for the current collection.” In response, the CPS execution server would typically call an external program to perform this function, because generating a makefile for an arbitrary collection is a very complex function to perform. A makefile is one possible means for implementing third-level processing commands.

Once a makefile has been generated, the CPS scheduler can issue second-level commands (e.g. “make all”) that are actually implemented by command sequences in the third-level makefile. For example, a second-level command of “make all” is actually implemented by third-level command sequences in the generated makefile. Neither the CPS scheduler nor the CPS execution server has any idea of what commands will actually be executed when the CPS scheduler instructs the CPS execution server to issue a “make all” command. Only the makefile generator has a deep understanding of makefile contents.

After all commands from the second-level expansion have been issued to and executed by CPS execution servers, the CPS scheduler reports job results for the job triplet request and dequeues the completed job triplet request. In addition, at a higher level of abstraction, after all expanded job triplet requests for a particular “do this to that” symbolic job request have been completed, the CPS scheduler reports overall job results and dequeues the original symbolic job request.

Command Abstraction Levels in a CPS System

Readers should note that there are three abstraction levels of job commands in the present CPS invention. The first-level command is the symbolic “do this” command, which uses a symbolic, user-defined task name. The second-level commands are the prologue, main, and epilogue commands, such as “checkout,” “generate makefile,” “make all,” and “make install,” and “delete collection.” The third-level detailed commands are the commands within the generated makefile that actually do the “real” work of processing a collection, by invoking collection storage systems, compilers, and other operating system programs.

The first abstraction level is comprised of the “do this” command. This level contains a user-defined symbolic task name that is part of a symbolic job request.

The second abstraction level is comprised of symbolic process commands that are created when the CPS system expands a symbolic “do this” task name into a sequence of prologue, main, and epilogue commands. These CPS-generated, process-oriented commands prepare, execute, and clean up the computation required by the symbolic task name. Second-level commands are called “task parts.” Task parts are predefined, and are stored in a knowledge base for use during symbolic task expansion operations.

Typical prologue commands include commands to “check out” (retrieve) a copy of a collection from a remote collection storage system into a local filesystem workspace, and commands to dynamically generate an optimal makefile to carry out the intent of the original symbolic job request. Those skilled in the art will recognize that these prologue operations are very familiar first steps in performing an automated software build. That is, all typical software build scripts must first obtain the software to be built (usually by checking out source files from a configuration management system), and then must ensure that a proper makefile is present to carry out the software build.

Typical main commands for a software build operation include commands to compile, link, and test a newly created executable program. For non-software build operations, other main command sequences would be appropriate.

Typical epilogue commands include commands to use the results of the main computation in some way, or to clean up the workspace after the main computation completes. Examples of epilogue commands to use computation results might include commands to copy or install newly built files to various locations, or to perform regression tests on constructed software files. Examples of workspace cleanup operations might include epilogue commands to delete the collection that was processed from the workspace, or “checking in” modified source code files into a collection storage system.

Prologue and epilogue commands are modeled and implemented by the CPS system itself, using symbolic task name tables, task name definition files, task part names, task part definition files, and associated software modules to instantiate prologue and epilogue commands. (These inventive structures and methods are described later in this document.) No technical significance is associated with prologue, main, and epilogue commands. These labels are only for presentation convenience.

The third abstraction level is comprised of detailed command sequences that are created when CPS execution servers call an external program to generate a custom makefile. A generated makefile typically embodies a large amount of detailed process knowledge about how to perform specific operations on the current collection, using programs on the current computing platform.

In a preferred implementation, a generated makefile typically embodies all command sequences for all operations known to a Collection Knowledge System 125 used by the makefile generator program. Using a generated makefile, people can easily perform any operation (known to the makefile generator system, that is) on the collection for which the makefile was generated. Typical generated makefiles contain many hundreds of lines of code, even for simple collections. For complex collections, generated makefiles can easily contain thousands of lines of code for performing optimal, customized operations using parallel execution methods.

Using three levels of command abstractions provides significant advantages in simplicity, process modelling power, and platform-dependent execution power.

At the first level of abstraction, all task commands look syntactically identical, and are stripped of details involving platforms, dependency orderings, machine names, and other low-level processing information. This means that most people can understand and work with top-level commands such as “do this to that.” Accordingly, people find it easy to perform complex operations on large sets of collections. To use a military analogy, a top-level command might be very abstract, such as “defeat the enemy.”

At the second level of abstraction, task commands are expanded into high-level, process-oriented command sequences that set up, execute, and clean up user-defined computational processes. Second level commands comprise a process management abstraction layer that is concerned with setup and execution of processes required to carry out the intent of the top-level command. To use a military analogy, a general would issue second level commands to prepare, execute, and cleanup various battles that comprise a war.

At the third level of abstraction, commands such as “make all” are implemented by detailed command sequences within a generated makefile. To use a military analogy, third-level commands within a makefile are the front line troops that call compilers, link object files together, move files around, and otherwise carry out the computations required by first and second level commands.

It is worthwhile to point out again that first level commands are extremely simple and stripped of all processing details. First level commands are concerned with referencing symbolic, user-defined tasks that have a known meaning to people who invoke the tasks.

Second level commands are concerned with computational process management (setup, execution, and cleanup). They contain no specific details about what actually happens when a “make all” command is issued at the third level.

Third level commands are concerned with executing specific computational operations by invoking various programs to process current collections. Third level commands are dynamically generated into makefiles to produce executable, parallel-enabled command sequences that are optimally customized to fit the particular collection, machine, task, and execution context at hand. Third level commands know nothing about process management at the second level, or about symbolic task names at the first level.

Now that we have introduced the main building blocks of the present Collection Processing System, we can start to dig deeper into low-level implementation details.

Structure of the Following Disclosure

The rest of this disclosure is concerned with two main topics—how to expand symbolic task names (“do this”) and collection references (“to that”) into executable command sequences that carry out the intent of the symbolic job request.

We treat collection reference expansions first. To this end, the following sections introduce collections, multiple collections, collection storage systems and collection namespaces, collection references that point into namespaces, and expansion of collection references into job triplets that contain individual collection names, computing platforms, and processing dependency order values.

We treat symbolic task name expansions second. To this end, we explain in detail three levels of command abstraction, using symbolic task name tables, task name definition files, task part name tables, task part definition files, and an end-to-end example for rebuilding a collection.

Introduction to Collections

This patent application uses special terminology and associated lexicographic meanings to clearly define the inventive concepts and structures of the present invention.

Many of the special terms below define inventive data structures that play a major role in the present invention.

Readers should be careful not to confuse the intended meanings of special terms such as “collection” in this application with the common dictionary meanings of these words. In particular, much novel and inventive structure is introduced into the claims by including these special terms in claim clauses that narrow and limit said claims.

Collections are inventive data structures that enable both people and programs to manipulate sets of computer files in “smart” ways, according to the data type of the collection and the processing policies defined for particular collection data types.

Collection information is comprised of three major parts: (1) a collection specifier that contains information—such as a collection data type—about a collection instance, (2) a collection type definition in a knowledge base that contains information about how to process all collections of a particular type, and (3) optional collection content in the form of arbitrary computer files that belong to a collection.

Collection specifiers contain information about a collection instance. For example, collection specifiers may define such things as the collection data type, a text summary description of the collection, collection content members, derivable output products, collection processing information such as process parallelism limits, special collection processing steps, and program option overrides for programs that manipulate collections. Collection specifiers are typically implemented as simple key-value pairs in text files or database tables. Collection specifiers are inventive data structures that contain strongly structured, machine readable and writeable information, and are very different than common text files such as “readme.txt” files.

Collection type definitions are user-defined sets of attributes that are stored in a central knowledge base so they can be shared among multiple collections. In practice, collection specifiers contain collection type indicators that reference detailed collection type definitions that are externally stored and shared among all collections of a particular type. Collection type definitions typically define such things as collection types, product types, file types, action types, administrative policy preferences, and other information that is useful to application programs for understanding and processing collections.

Collection content is the set of all files and directories that are members of the collection. By convention, all files and directories recursively located within a collection subtree are collection content members. In addition, collection specifiers can contain collection content directives that add further files to the collection membership. Collection content is also called collection membership.

Collection is a term that refers to the union of a collection specifier and a set of collection content.

Collection information is a term that refers to the union of collection specifier information, collection type definition information, and collection content information.

Collections have many practical applications in the technical arts. They make it convenient for programs and human knowledge workers to manipulate whole data-typed sets of computer files where only individual files could be manipulated before. They make it possible to manipulate collections according to standard processing policies that are defined in a collection type definition in a shared database.

Collection Representations

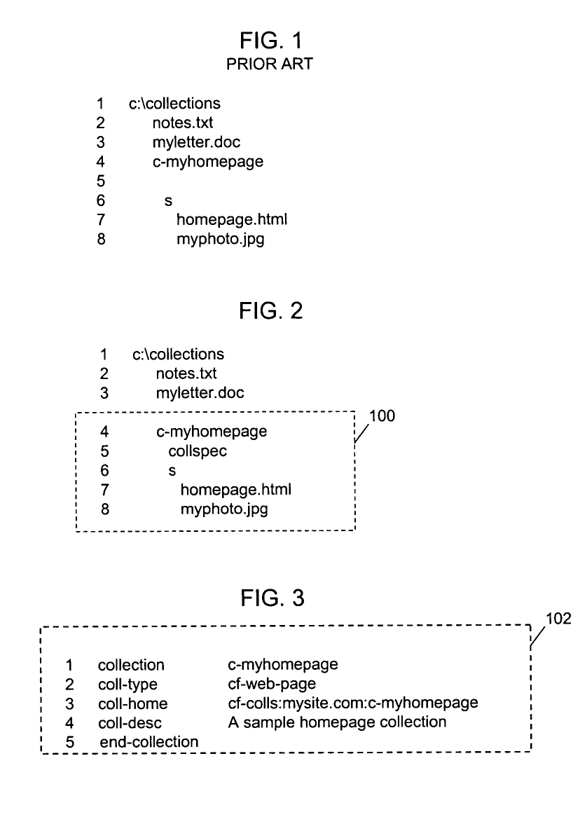

FIGS. 1-3 show a preferred embodiment of collections for a typical personal computer.

FIG. 1 shows a sample prior art file system folder from a typical personal computer. Since this file folder does not contain a collection specifier file, it does not meet the definition of a collection, and therefore is not a collection.

FIG. 2 shows the prior art folder of FIG. 1, but with a portion of the folder converted into a collection 100 by the addition of a collection specifier file FIG. 2 Line 5 named “collspec” (short for collection specifier). In this example, the collection contents FIG. 2 Lines 4-8 of collection 100 are defined by two implicit policies of a preferred implementation of collections.

First is a policy to specify that the root directory of a collection is a directory that contains a collection specifier file. In this example, the root directory of a collection 100 is a directory named “c-myhomepage” FIG. 2 Line 4, which in turn contains a collection specifier file 102 named “collspec” FIG. 2 Line 5.

Second is a policy to specify that all files and directories in and below the root directory of a collection are part of the collection content. Therefore directory “s” FIG. 2 Line 6, file “homepage.html” FIG. 2 Line 7, and file “myphoto.jpg” FIG. 2 Line 8 are part of the collection content for collection 100.

FIG. 3 shows an example collection specifier file 102, FIG. 2 Line 5, for use on a typical personal computer file system. Note that the collection specifier FIG. 3 Line 2 specifies the collection type of the collection to be “cf-web-page.” Collection types act as links between collection instances (located in properly structured file folders that contain a collection specifier file) and collection type definitions in a shared database. Programs extract a collection type such as “cf-web-page” from a collection specifier file, and use the extracted collection type as a lookup key into a table of collection types that in turn links to a full collection type definition.

Working with Multiple Collections

People and programs that work with collections frequently need to work with multiple collections at once. One practical example of this need is for software builds that involve multiple collections. Other practical examples are also possible, such as working with several collections of related documents, photos, data files, or web pages.

In many cases, there are processing dependencies among collections within a set of collections, requiring that some collections be processed before other collections. This is not a simple problem for automated programs to solve using prior art techniques, because there is no general way for programs to determine a correct processing order among an arbitrary set of files that reside in common filesystem folders. However, in contrast to prior art techniques, collections make it possible for automated programs to calculate a correct collection processing order.

It is important to understand that processing dependencies are not always caused by lexical file inclusion dependencies such as are commonly associated with “include” statements in programming languages. Instead, there may be link library dependencies, or dependencies concerning process-generated files, or even whimsical human preference dependencies. The prior art does not disclose structures for representing these concepts, or methods for automated programs to determine a proper processing order. In contrast, collections provide both inventive data structures and methods for representing and automatically determining a proper processing order, as the following disclosure will show.

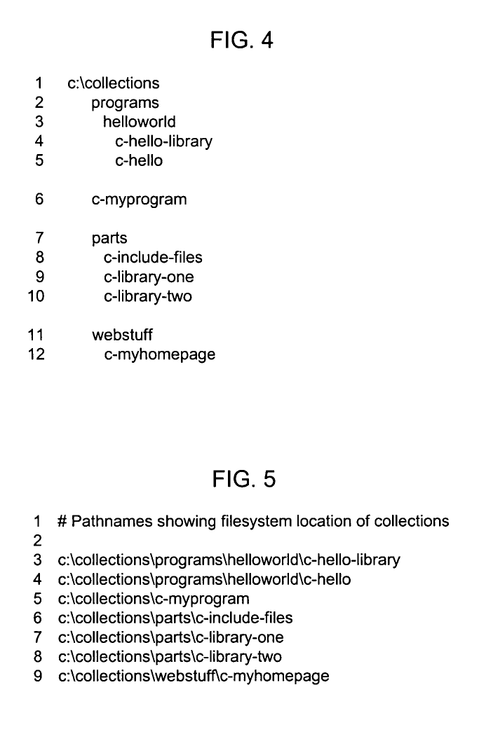

FIG. 4 shows a filesystem tree containing several collections, located at various hierarchical levels (depths) within a filesystem tree. This is a practical example of a tree that might be processed on a personal computer. It contains several collections of different collection types, including C program collections that use C library collections and a C include file collection, and a web page collection.

FIG. 5 shows a list of pathnames that show the filesystem locations of the collections in the tree of FIG. 4. This list of pathnames, if a program could calculate the list automatically, would enable an automated program to work with the set of collections as stored on a local filesystem. (Collection recognizers solve this problem. See the list of related patent applications at the front of this document for more information on Collection Recognizers.)

Determining the location of multiple collections on a local filesystem is not the subject of the present Collection Symbolic Job Expander invention. Instead, the problem addressed by the present invention is the problem of expanding collection symbolic job requests into lists of specific job requests that contain particular collection names, platform names, and visit orderings (dependency processing orderings).

For example, suppose that a person wanted to perform a predefined operation on all collections in the tree of FIG. 4. Suppose also that the person did not know where (or how) the collections in FIG. 4 were stored, and did not know what specific collections were in the tree. Suppose that all the person really knows is that they want to “do this (task) to that (set of collections in that tree).” Providing inventive structures and methods to overcome this example problem is the subject of the present Collection Processing System invention.

Collection Storage Systems

It is common practice in the software industry to store successive versions of computer files in a configuration management (CM) system. CM systems have a strong stabilizing effect on software development projects because they help to coordinate, control, and manage the constant stream of changes that are made to software files during a software project. For example, many modem software applications are comprised of thousands of individual computer files that are organized into related groups of files that are stored in many file folders. Mature software applications are often comprised of millions of lines of programming code.

Unfortunately, prior art CM systems can only represent and understand stored files at the file, directory, and tree levels. They have no more detailed, or more powerful way of understanding the files that they store. They can only understand simple operating system files and folders, or trees comprised of files and folders. In particular, prior art CM systems—with the exception of Collection Storage Systems—do not understand collections. See the list of related patent applications at the front of this document for more information on Collection Storage Systems.

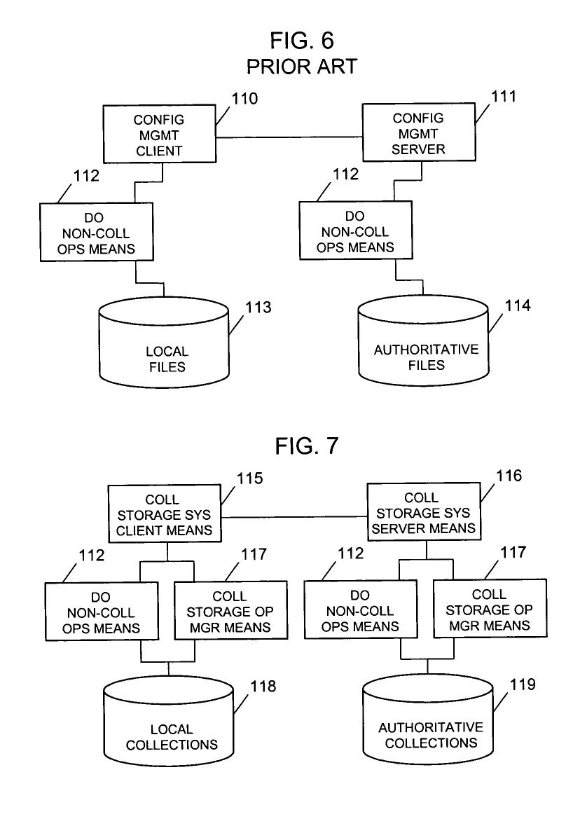

FIG. 6 shows a prior art CM system that does not understand collections. This system is incapable of performing collection-aware operations on collections. This system is comprised of a CM client module 110 and a CM server module 111. Both client and server modules can perform non-collection aware operations using a software operations module 112 that does not understand collection operations. The CM client 110 can transfer files from the authoritative CM server storage database 114 to its local filesystem 113, and back again. Typically, the CM client 110 will reference groups of files by explicit file name, by file folder name (a directory name), or by a user-defined symbolic group or module name that is a shortcut name for a single directory name.

Prior art CM systems enable people to reference groups of files by symbolic group name or file folder name, without requiring people to know precisely which files are included in the specified folder or group name. This is a convenient capability, because it relieves people of having to remember and manage detailed lists of files.

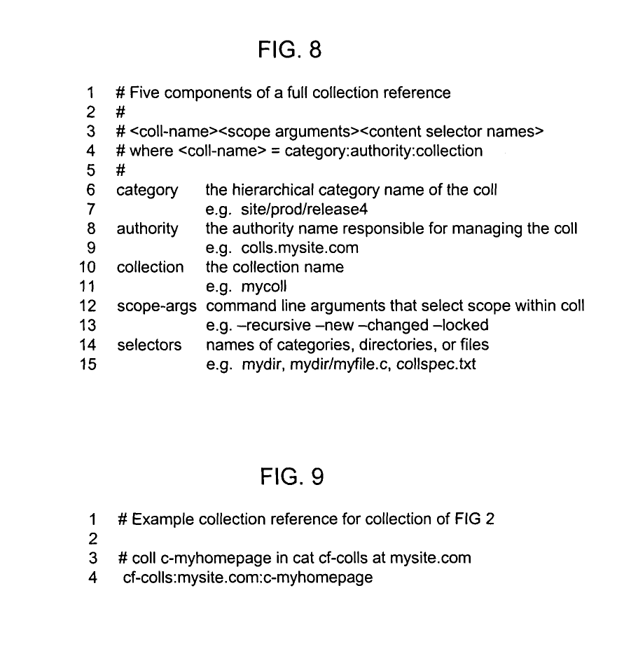

FIG. 7 shows a Collection Storage System (CSS) that does understand collections, and that is capable of performing collection-aware operations. In essence, a CSS system is similar to a prior art CM system, except that a CSS system understands inventive collection data structures and associated inventive methods for performing collection-aware operations. Understanding collections gives CSS systems a significant practical advantage in their representational and functional usefulness to people and programs that work with collections.

The CSS system shown in FIG. 7 is comprised of a CSS client module 115 and a CSS server module 116. Both client and server modules can perform non-collection aware operations using a software operations module Do Non-Collection Operations Means 112 that does not understand collection operations. But both client and server can perform collection-aware operations using a software operations module Collection Storage Operation Manager Means 117 that can perform collection-aware storage operations.

The CCS system shown in FIG. 7 is capable of moving whole collections—not merely files—from an authoritative database of collections 119 to a local filesystem 118, and back again. Being able to work with collections, and not being limited to only working only with files or directories, gives the CSS system shown in FIG. 7 significant productivity and functionality advantages over prior art CM systems.

The next section describes how the collections in the tree of FIG. 4 might be stored and referenced within a collection storage system, using collection reference expressions.

Collection References

Collections are useful and practical software containers for computer files because collections make it much easier for people to work on whole data-typed sets of related computer files with simple commands. Computer programs can work with collections too, but the programs must usually know where collections are physically located on a filesystem before performing operations on the collections.

In particular, computer programs can work on collections most easily if the programs are invoked in a working directory that is contained within a proper collection directory structure that contains a collection specifier file.

In contrast, automated computer programs cannot easily reference collections from a working directory that is outside a collection, because a suitable referencing means is required for referencing external collections. For example, an automated program that is invoked inside a directory inside a collection can effectively refer to “this collection,” but there is no easy way of saying “that collection over there” except by using a long filesystem pathname. The restriction of always being forced to work on collections from within local collection directory structures is a significant limitation in processing flexibility.

Collection storage systems and collection references overcome this limitation by enabling people and programs to refer to collections that are stored within a collection storage system. Such an arrangement allows people to refer to collections by unique symbolic name, thereby saving themselves the effort of remembering and typing in long pathnames that are likely to change.

Several different kinds of collection references are possible. To show the underlying technical structure of collection references, the following discussion starts with definitions for simple expressions and builds up to definitions and examples of full collection references.

Expressions are comprised of sequences of characters. Expressions have no meaning until a human or program interprets them with respect to a set of interpretation rules. For example, numeric expressions are comprised of numbers, alphabetic expressions are comprised of letters, and alphanumeric expressions are comprised of both letters and numbers.

References are comprised of expressions that refer to something when humans or programs interpret expressions with respect to a set of interpretation rules. For the sake of convenience, humans often name or classify references according to either the syntactic form of the reference or according to the target of the reference (the referent). For example, here are some examples of references that are named after the syntactic form of the reference: numeric references, pointer references, HTTP URL references, and FTP references. In contrast, here are some examples of references that are named after the things that are pointed to by the reference: document references, file references, and collection references.

Collection References are comprised of expressions that, when interpreted, refer to collections. Collection references can refer to collections in three ways: by location (that is, by pathnames), by internal collection properties such as collection type (“all web page collections”), or by symbolic name (“mycollection:mysite.com”). Each of these three collection reference methods is described in more detail below.

First, references to collections by location are references to file folders or directories in computer file systems. This method works because collections are normally stored in file folders or hierarchical directory structures in computer file systems. The content of a directory structure, including the presence of a valid collection specifier, ultimately determines whether a directory actually contains a collection. Those skilled in the programming arts will also appreciate that there is no other way to refer to something by location in a typical computer filesystem, except by its pathname location.

Second, references to collections by internal properties such as collection type are usually search expressions that programs use to find and select interesting collections from a group of collections for processing. For example, a searcher might want to refer to all collections of a particular collection type within a collection namespace or within a computer file system.

Third, references to collections by name only have meaning within collection namespaces that are defined by humans or application programs that manage entries in the namespace. For example, a configuration management system that understood collections would specify a particular syntax for referring to collections by name within the managed namespace.

Here is one practical example of a collection reference name syntax: “<category>:<authority>:<collection>.” The first category part of the name is a hierarchical expression (like a directory pathname) that categorizes collections into groups within a collection namespace. The second authority part is the name of a network authority (usually an Internet hostname such as “host.mysite.com”) that manages a collection namespace. The third collection part is the name of a specific collection, within the category, within the collection namespace, that is managed by the authority.

The present Collection Processing System invention uses the third collection referencing method, collection reference by name, including the “<category>:<authority>:<collection>” syntax described above. Collection references by name are normally much more convenient than are collection references by location or by type or properties.

Shortcut Collection References

Shortcut Collection References are convenient, short-form collection name references that reduce typing effort and reduce knowledge burdens on human users. The main idea of shortcut collection references is that people can save typing by omitting various parts of a normal collection reference. Application programs can fill in missing parts of a shortcut reference by using default values from a current local working collection, or by using default values that are specified by the application program itself.

The next section describes the syntax of both complete and shortcut collection references.

Collection Reference Representations

FIGS. 8-10 show formats for collection references and shortcut references.

FIG. 8 shows the structure of a complete collection reference. FIG. 8 Line 3 shows three major syntactic components of a preferred implementation of a complete collection reference—a collection reference name (category:authority:collection), a set of scoping arguments, and a set of content selector arguments. The first component, a collection reference name, is mandatory. The other two components, scoping arguments and content selector arguments, are optional.

A collection reference name is comprised of three parts—a category name, an authority name, and a collection name. A category name is a hierarchically structured name that groups related collections into categories, just as directory folders group related computer files into directories. An authority name is the name of an authority that is responsible for managing a collection. In practice, an authority name is an Internet Domain Name of a host computer that executes a server program for managing collections. A collection name is the name of a collection.

A collection reference scoping argument modifies a collection reference to refer to particular portions of a whole collection. For example, a “-recursive” scoping argument indicates that a reference should recursively include all directories and filenames below the recursion starting directory. Other examples of scoping arguments include “-new,” “-changed,” “-old,” “-local,” “-remote,” and “-locked.” In a collection storage system, these scoping arguments limit the scope of a collection reference to particular directories and filenames by comparing a local collection copy with a remote authoritative collection copy. Scoping arguments enable people to reference only the collection directories and files that interest them.

A collection reference content selector is a particular category, directory, or filename that limits a collection reference to include particular named categories, directories, or filenames. Collection reference content selectors act like collection reference scoping arguments, to limit the scope of a collection reference. But whereas scoping arguments use properties of collection elements (such as new, locked, changed) to limit collection references, content selectors use explicit names of collection content members to limit a collection reference.

FIG. 9 shows an example collection reference that is a normal “whole collection” reference for the collection shown in FIG. 2. Keep in mind that the syntax shown (“category:authority:collection-name”) is a collection reference that has meaning only within a collection namespace that is managed by a collection storage system

Syntax of Shortcut Collection References

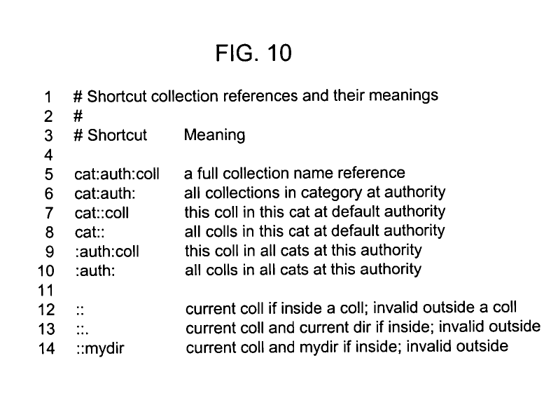

FIG. 10 shows a table of shortcut collection references and their meanings. A shortcut collection reference omits one or more parts of a normal three-part collection reference name. For example, FIG. 10 Line 6 shows a shortcut reference that omits the third component of a collection reference name, and thereby refers to “all collections” in a specified category at a specified authority.

Shortcut collection references are very useful in practice. They save typing. They reduce reference errors. They provide increased referencing power. They provide flexibility for referencing multiple categories of collections, authorities, and individual collections. Indeed, shortcut collection references have more referential power than complete three-part collection reference names. This is because complete collection names must provide specific values for a category and a collection, and so cannot refer to all categories, or all collections.

One of the functions of the present Collection Processing System invention is to expand shortcut collection references within symbolic job requests into lists of complete three-part collection reference names.

Local and Remote Collection References

FIG. 10 also shows both local and remote collection references. Lines 12-14 show local collection references, and Lines 5-10 show remote collection references.

Local Collection References refer to a current working collection. A current working collection for a program that is making a local collection reference is defined to contain the working directory of the program. Local collection references have no meaning, and are invalid, if no collection contains the working directory of a computer program that is making a local collection reference. In the examples presented in this disclosure, local collection references begin with a double colon “::” as shown in FIG 10 Lines 12-14. Other syntaxes are also possible, and would be determined by the collection storage system implementation that manages the namespace.

Remote Collection References do not require that a program's current working directory be within a collection directory structure. A valid remote collection reference can be made from within any file system directory, whether inside or outside of a collection directory structure. Remote collection references are interpreted by programs that manage access to a set of collections, such as a collection storage system. In the examples presented in this disclosure, remote collection references do not start with a double colon “::” character sequence. Other syntaxes are also possible, as determined by the implementation policies of host collection storage systems.

FIG. 10 Line 14 shows a reference that could be construed as a remote reference that means “all categories at all authorities that contain a collection called ‘mydir’.” This interpretation is legitimate because it is in accordance with the conventions that have been presented above for remote collection references. But that is not the meaning used in this disclosure. Instead, it is more advantageous to use this particular syntax (“::dir”) to refer to local partial collections, for two reasons. First, this syntax is rarely, if ever, used for remote references in practice. Second, the double colon at the beginning of the reference makes it look like a local reference, so it would cause confusion among users if it were used as a remote reference. For these reasons, preferred implementations treat the syntax (“::dir”) as a local collection reference.

Keep in mind that the interpretation of a collection reference is ultimately determined by the implementation policies of the computer program that interprets the reference. This is why other syntaxes are also possible. For example, an application program could specify that local collection references should begin with a double sequence of a non-colon character such as “x.” Then the three shortcut local references shown in FIG. 10 Lines 12-14 would be “xx” “xx<dot>” and “xxdir” (where <dot> means a period). Or a slash could be used, giving “//” “//<dot>” and “//dir.” This disclosure, which explains a preferred implementation, uses double colons for shortcut local collection references, to maintain a consistent look among all collection references. But other implementations are also possible.

Symbolic Job Requests

Having described collections, collection storage systems, and collection references to reference sets of collections within a namespace that is managed by a collection storage system, we now turn our attention to collection symbolic job requests.

The following sections describe collection symbolic job requests and a format for expanded job triplet lists.

Collection Symbolic Job Requests

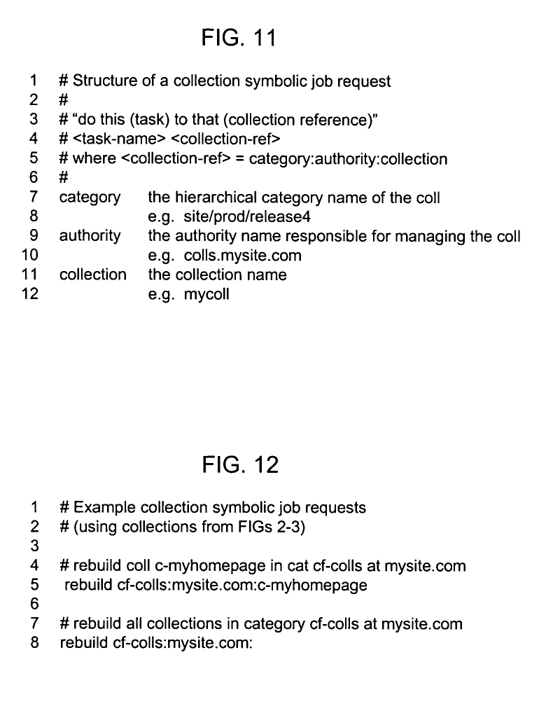

FIG. 11 shows the structure of a collection symbolic job request. The intent of a symbolic job request is to make it easy for humans to apply operations to large groups of collections, without having to specify tedious processing details such as particular collection names, processing visit orders, or processing platform names.

A collection symbolic job request has two parts: a symbolic task name and a collection reference name. FIG. 11 Line 4 shows the syntactic structure of a two-part collection symbolic job request.

A symbolic task name is the name of an operation that should be performed by the computer program that carries out the symbolic job request. Arbitrary user-defined operations and operation names are possible, limited only by the capabilities of the job processing system. For example, some symbolic task names could be “checkout,” “compile,” “rebuild,” “regression-test,” and “install.”

A collection reference name is comprised of three parts—a category name, an authority name, and a collection name. As discussed previously, a collection reference name can be a shortcut reference name, and can refer to individual collections or sets of collections within a managed collection namespace.

FIG. 12 shows two example collection symbolic job requests. FIG. 12 Line 5 shows a request to rebuild an individual collection “cf-colls:mysite.com:c-myhomepage.” FIG. 12 Line 8 shows a request to rebuild all collections in category “cf-colls” in the collection namespace managed by authority “mysite.com.”

The main job of the present Collection Processing System (CPS) invention is to carry out all processing that is implied by a top-level symbolic job request such as FIG. 12 Line 8, including managing the expansion of a symbolic job request into a list of more detailed job requests that contain specific collection names, visit orders, and processing platform names.

Expansion of Symbolic Job Requests

There are three main steps in a collection reference job expansion action.

The first step is to expand shortcut collection references into an expanded list that contains individual collection names.

The second step is to determine a correct processing dependency ordering for all collections on the expanded list of individual collections.

The third step is to determine a set of computing platforms for each collection on the expanded list of individual collections.

To give readers a visual idea of how a symbolic job request is expanded into job triplet requests that can actually be executed by a CPS system, the following sections explain the function and outputs of the three expansion steps.

Collection Reference Name Expansion

The first step in performing a collection symbolic job request expansion is to expand shortcut collection reference expressions (that symbolically reference a set of collections) into a list of individual, specific collection names.

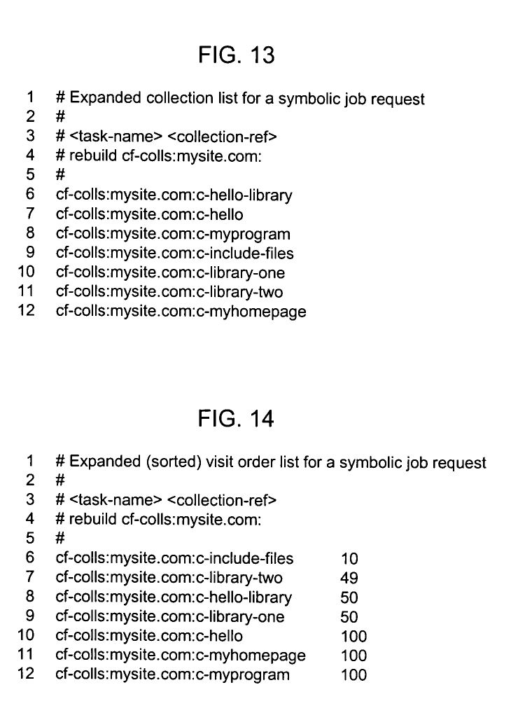

FIG. 13 shows the results of a collection reference name expansion. Line 3 reiterates the syntactic structure of a collection symbolic job request. Line 4 shows an example symbolic job request to rebuild all collections in category “cf-colls” in the collection namespace managed by authority “mysite.com.” By intent, FIG. 4 shows one possible filesystem structure that a collection storage system might use to represent the collections indicated by the shortcut reference “cf-colls:mysite.com.” Accordingly, all collections shown in FIG. 4 are listed in the expanded collection list of FIG. 13 Lines 6-12.

FIG. 13 Lines 6-12 show an expanded list of individual collection names for the collection symbolic job request of FIG. 13 Line 4. Individual collection names in Lines 6-12 happen to appear in the same vertical order as shown in FIG. 4, but no strong ordering among collections is either intended or necessary for this part of the job expansion process. Proper visit ordering is a separate step in the expansion process.

In a preferred implementation of a CPS system, collection reference name expansion is a function that is performed by an external Collection Symbolic Job Expander program. See the list of related patent applications at the front of this document for more information on Collection Symbolic Job Expanders.

Visit Order Expansion

Once a list of individual collection names has been calculated from a shortcut reference in a symbolic job request, a proper visit ordering must be calculated to ensure that individual collections are processed (“visited”) in the desired order.

FIG. 14 shows the results of a sorted visit order expansion. Line 4 shows the original symbolic job request.

Lines 6-12 Column 1 shows the list of individual collection names that resulted from expanding the shortcut collection reference name of Line 4 Column 2.

Lines 6-12 Column 2 shows a list of visit order ranking values associated with the collections names of Column 1. Lines 6-12 have been sorted into proper visit order, according to the visit order values in Column 2.

As can be seen, the sorted order of individual collection names FIG. 14 Lines 6-12 is not the same as the original list of collection names FIG. 13 Lines 6-12. This is because the original list of collection names was not in proper visiting order.

In a preferred implementation of a CPS system, visit order expansion is a function that is performed by an external Collection Symbolic Job Expander program. See the list of related patent applications at the front of this document for more information on Collection Symbolic Job Expanders.

Platform Expansion

The third step in a symbolic job expansion process is to expand the list of individual collections by processing platform names. Recall that it may be necessary to perform the original symbolic task operation on each collection in the list, on multiple computing platforms. For example, source code files for a computer application program might have to be compiled for several popular personal computer operating systems (platforms).

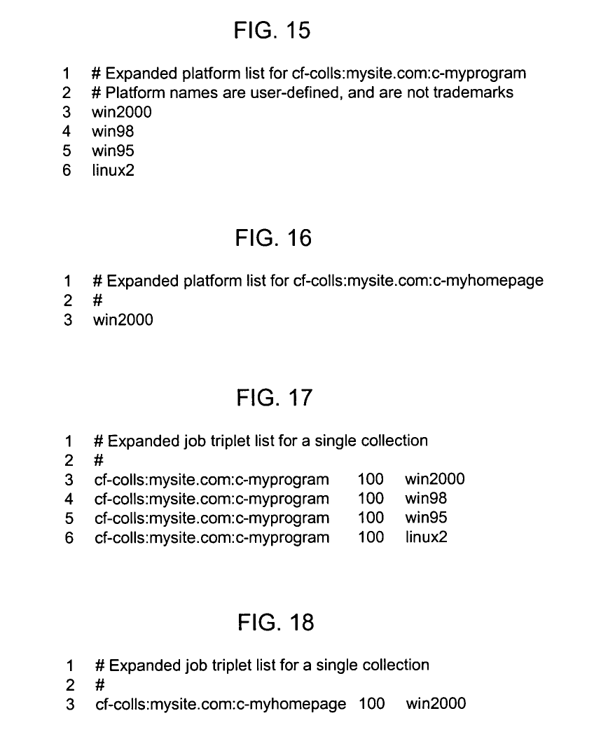

FIG. 15 shows a list of four example user-defined computing platform names (these names are user-defined, they are not trademarks). Line 1 shows the name of a collection “cf-colls:mysite.com:c-myprogram” for which the list of platform names was determined.

FIG. 16 shows a list of one computer platform, this time for a different collection. Line 1 shows the name of a collection “cf-colls:mysite.com:c-myhomepage” for which the list of one platform name was determined.

FIGS. 15-16 are an example of the principle that different collections can be processed on different sets of computing platforms. Accordingly, collection symbolic job expanders must be capable of producing different sets of platform lists for different collections.

In a preferred implementation of the present CPS invention, platform expansion is a function that is performed by an external Collection Symbolic Job Expander program. See the list of related patent applications at the front of this document for more information on Collection Symbolic Job Expanders.

Expanded Job Triplets

Once visit order and platform expansion values have been determined for an individual collection name, all three values are organized into a “job triplet” that specifies detailed processing information for one individual collection. Ultimately, all triplets for all collections in an expansion are organized into a big list that is the output of a collection symbolic job expansion process.

FIG. 17 shows the results of a collection reference, a visit order, and a platform expansion for a single collection “cf-colls:mysite.com:c-myprogram.” Lines 3-6 show four expanded job triplet lines because four computing platforms are required for this particular collection (win2000, win98, win95, linux2).

FIG. 18 shows the results of a collection reference, visit order, and platform expansion for a single collection “cf-colls:mysite.com:c-myhomepage.” Only one expanded job triplet line is required because this particular collection only requires processing on one computing platform (win2000).

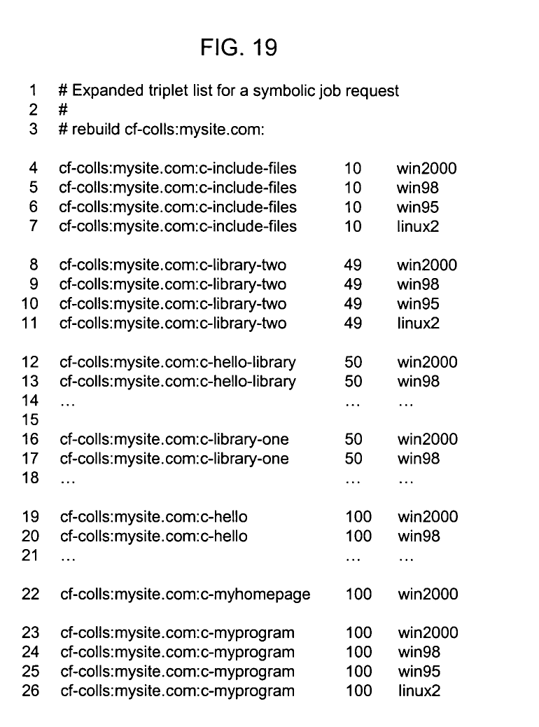

FIG. 19 shows the results of a collection reference, a visit order, and a platform expansion for the original symbolic job request of FIG. 12 and FIG. 13. FIG. 19 Line 3 shows the original symbolic job request. FIG. 19 Lines 4-26 show a list of job triplets for all collections indicated by the shortcut collection reference in the original symbolic job request. Some triplets Lines 14, 18, 21 have not been shown because of space limitations. Ellipsis characters mark the position of missing triplets.

Job Expander Data Structures

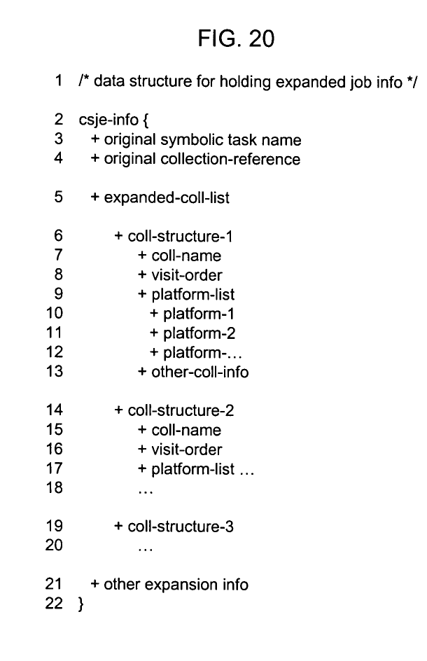

FIG. 20 shows an inventive data structure for holding collection symbolic job expansion information. Line 3 holds the name of a symbolic processing task, which is associated with all job triplets produced by a collection reference expansion to produce “job quadruplets”. Line 4 holds the name of an input (possibly shortcut) collection reference. Lines 5-20 hold a list of expanded collection names.

FIG. 20 Lines 6-13 hold expansion information for an individual collection. Line 7 holds a single expanded collection name. Line 8 holds a visit order ranking value for the collection. Line 9 holds a list of platform names for the collection. Lines 10-12 hold particular platform names for the collection. Line 13 holds other information that might be required by a particular implementation of the collection symbolic job expander principles set forth in this document.

Collection Processing System Architecture #1

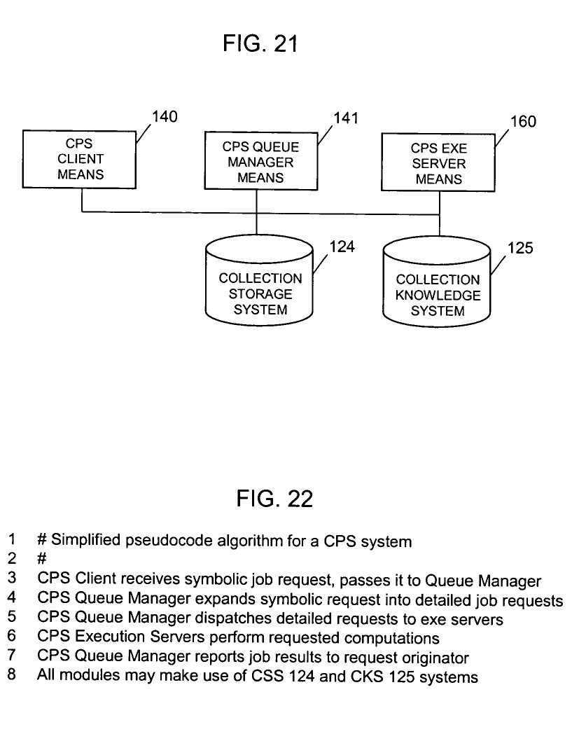

FIG. 21 shows a simplified architecture for a CPS system that can carry out convenient, user-friendly symbolic job requests by expanding them and assigning the expanded job requests to CPS execution servers.

Module CPS Client Means 140 is responsible for obtaining symbolic job requests from request originators (either people or programs) and forwarding the symbolic job requests to module CPS Queue Manager Means 141. As described earlier, symbolic job requests are the first level of command abstraction in the present CPS invention.

Module CPS Queue Manager Means 141 is responsible for expanding the symbolic job request into a list of detailed job requests, dispatching detailed job requests to module CPS Execution Server Means 160 for execution, and reporting completed job results back to the symbolic job request originator. For each detailed job request, CPS Queue Manager Means 141 is responsible for expanding the symbolic task name into a sequence of prologue, main, and epilogue commands that collectively set up, execute, and clean up the computations associated with the original symbolic task name. As described previously, prologue, main, and epilogue commands are the second level of command abstraction in the present CPS invention.

Module CPS Execution Server Means 160 is responsible for executing the prologue, main, and epilogue commands generated by CPS Queue Manager Means 141. Prologue commands typically instruct CPS Execution Server Means 160 to check out a collection from a Collection Storage System 124, and to generate a custom makefile that contains detailed executable command sequences that carry out the main processing required by the original symbolic task name. As described earlier, commands inside the generated makefile are the third level of command abstraction in the present CPS invention.

Major External CPS Supporting Systems

The CPS architecture shown in FIG. 21 makes use of two major external supporting systems, a Collection Storage System 124, and a Collection Knowledge System 125. Module Collection Storage System 124 is a software system that can perform collection-oriented configuration management operations. In addition, Collection Storage System 124 defines and manages a collection namespace for stored collections, thereby enabling other programs to reference stored collections using collection reference expressions.

Module Collection Storage System 124 is an external software system that provides services to the present CPS invention. See the list of related patent applications at the front of this document for more information on Collection Storage Systems.

Module Collection Knowledge System 125 is a knowledge base of collection-oriented information that is useful to programs that work with collections. In particular, Collection Knowledge System 125 contains much information that is useful to both Collection Storage System 124 and to the present CPS invention, including collection type definitions, symbolic task name and task definition tables, task part name and definition tables, CPS execution server configuration and management information, and per-collection instance overrides for various kinds of knowledge data that are normally stored in a Collection Knowledge System 125.

Module Collection Knowledge System 125 is an external software system that provides services to the present CPS invention. See the list of related patent applications at the front of this document for more information on Collection Knowledge Systems.

Collection Processing System Algorithm #1

FIG. 22 shows a simplified algorithm for the CPS system of FIG. 21.

In operation, CPS Client Means 140 receives a symbolic job request from a request originator (either a person or a program), and forwards the request to CPS Queue Manager Means 141.

Module CPS Queue Manager Means 141 expands the symbolic job request into a list of detailed job triplet requests that each contain an individual collection name, a computing platform, and a processing dependency visit order, as shown in FIG. 19. The original symbolic task name is also associated with each expanded job triplet request, as shown by the example data structure in FIG. 20, Line 3.

Module CPS Queue Manager Means 141 dispatches expanded job triplet requests to a CPS Execution Server Means 160 for execution. As part of the dispatching operation, CPS Queue Manager Means 141 expands the first-level original symbolic task name into a sequence of second-level prologue, main, and epilogue commands that are passed to CPS Execution Server Means 160 for execution.

Module CPS Execution Server Means 160 expands incoming second-level prologue, main, and epilogue commands that it receives from CPS Queue Manager Means 141 into third-level executable commands, and then executes the third-level commands. It also reports job results back to the CPS Queue Manager Means 141. In turn, CPS Queue Manager Means 141 reports job results back to the symbolic job request originator.

Hardware Assignment of CPS Modules

CPS system modules are typically distributed over multiple physical computers, thereby forming a distributed, scalable, multiplatform CPS implementation.

In one possible preferred assignment of modules to computers, multiplatform CPS Client Means 140 modules run on all client computers that are accessible to people and programs that use a CPS system. A CPS Queue Manager Means 141 runs on a central management computer. Finally, one or more CPS Execution Server Means 160 modules run on each “workhorse” execution computer.

In a typical multiplatform CPS implementation, both client modules and execution modules run on all computing platforms in the CPS system, thereby providing full multiplatform coverage of all platforms that are available to the system. Full coverage means that people can issue CPS symbolic job requests on any computer, using a CPS Client Means 140 for that computing platform. It does not matter if the symbolic job request causes computations to occur on multiple execution server machines involving different computing platforms.

Full coverage also means that people can issue any user-defined symbolic task on any client computer, and invoke the full processing knowledge of both a Collection Knowledge System 125 and the processing power of all multiplatform CPS execution servers to perform the “real” work of a symbolic job request.

The present CPS invention thereby greatly increases the productivity of people who need to perform complex operations on large sets of collections.

Collection Processing System Architecture #2

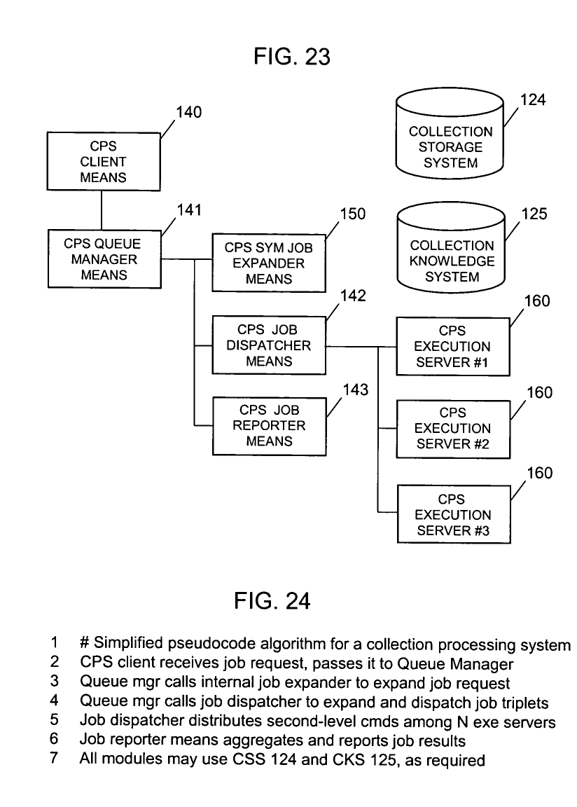

FIG. 23 shows a simplified architecture of a Collection Processing System that shows several more subordinate modules that help CPS Queue Manager Means 141 to perform its primary functions.

The main difference between the previous architecture of FIG. 21 and the current architecture of FIG. 23 is that the current architecture shows more detail about the internal structure and functions of CPS Queue Manager Means 141. In particular, the current architecture of FIG. 23 performs symbolic job expansion internally. (A third architecture shown later in this document shows a preferred CPS architecture that performs symbolic job expansion externally.)

Module CPS Client Means 140 receives collection symbolic job requests from people or programs, and forwards symbolic job requests to CPS Queue Manager Means 141.

Module CPS Queue Manager Means 141 receives incoming symbolic job requests and passes them to internal module CPS Symbolic Job Expander Means 150 for expansion into job triplet lists.

Module CPS Job Dispatcher Means 142 receives a list of expanded job triplet requests. It matches job triplet requirements (such as computing platform) to execution server attributes (such as computing platform), and dispatches individual job triplet requests to individual CPS Execution Servers 160. As part of the dispatching process, CPS Job Dispatcher Means 142 expands each symbolic task name into a sequence of second-level prologue, main, and epilogue commands that are each executed by a CPS Execution Server Means 160, one at a time.

Module CPS Execution Server 160 receives second-level prologue, main, and epilogue commands from CPS Job Dispatcher Means 142, and executes the commands as requested. CPS Execution Servers 160 report job status information back to CPS Job Dispatcher Means 142 for every prologue, main, and epilogue command that is executed.

Module CPS Job Reporter Means 143 is a utility module that collects job status information from modules CPS Queue Manager Means 141 and CPS Job Dispatcher Means 142, and reports accumulated job status back to the original symbolic job request originator. In a preferred implementation, job status reports are sent out by email, since CPS jobs may not produce completion status information for hours and hours, long after the request originator has quit for the day.

Internal Symbolic Job Expansion

Continuing with FIG. 23, module CPS Symbolic Job Expander 150 expands incoming symbolic job requests into more detailed job triplet requests. Some example job triplet requests are shown in FIG. 19. A data structure suitable for storing completed job expansion information is shown in FIG. 20.

In a preferred implementation, symbolic job expansion is not performed by the CPS system itself. Instead, it is advantageous to perform job expansion using an external program to ease the computational load on the central CPS queue manager computer. The external job expansion program is a supporting, but external system that provides services to the present CPS invention.

Those skilled in the art will recognize that internal and external symbolic job expansion methods are functionally equivalent, even though external expansion has a practical advantage in helping to distribute computational load across multiple computers.

Accordingly, the detailed structures and methods of module CPS Symbolic Job Expander 150 are not described in detail in this document. Instead, interested readers should see the list of related patent applications at the front of this document for more information on Collection Symbolic Job Expanders.

Collection Processing System Algorithm #2

FIG. 24 shows a simplified algorithm for the CPS architecture of FIG. 23. The algorithm of FIG. 24 is similar to the previous algorithm of FIG. 22, but with more detail added.

In operation, CPS Client Means 140 receives a symbolic job request from a request originator (either a person or a program), and forwards the request to CPS Queue Manager Means 141.

Module CPS Queue Manager Means 141 calls CPS Symbolic Job Expander Means 150 to expand the symbolic job request into a list of detailed job triplet requests that each contain an individual collection name, a computing platform, and a processing dependency visit order, as shown in FIG. 19. The original symbolic task name is also associated with each expanded job triplet request, for later expansion, as shown by the example data structure in FIG. 20, Line 3.

Next, module CPS Queue Manager Means 141 calls CPS Job Dispatcher Means 142 to dispatch expanded job triplet requests to various CPS Execution Server Means 160 for execution. As part of the dispatching operation, CPS Queue Manager Means 141 expands the original symbolic task name into a sequence of second-level prologue, main, and epilogue commands that are passed to CPS Execution Server Means 160 for execution. (A detailed explanation of symbolic task expansion is provided later in this document.)

Module CPS Job Dispatcher Means 142 calculates second-level prologue, main, and epilogue commands using tables and definitions from a Collection Knowledge System 125, and dispatches them one at a time to a suitable CPS Execution Server Means 160.

Module CPS Job Dispatcher Means 142 chooses a suitable CPS Execution Server Means 160 primarily by matching job triplet platform values with platform values supported by execution servers. Other matching criteria are also possible, such as hardware performance indicators (e.g. a job triplet can request a “fast” machine instead of a “slow” machine).

Modules CPS Execution Servers 160 receive individual second-level prologue, main, and epilogue commands from CPS Job Dispatcher Means 142, expand second-level commands into third-level commands (as described later in this document), and execute the third-level commands to fulfill the processing intent of the second level commands. CPS Execution Servers report job status information back to CPS Job Dispatcher Means 142 for every prologue, main, and epilogue command that is executed.

Finally, CPS Queue Manager Means 141 calls CPS Job Reporter Means 143 to organize job status information and report job results back to the symbolic job request originator. In a preferred implementation, job status reports are sent out by email, since CPS jobs may not produce completion status information for hours and hours, long after the symbolic job request originator has finished running the CPS Client Means 140 that was used to submit the original job request.

Module CPS Execution Server Means

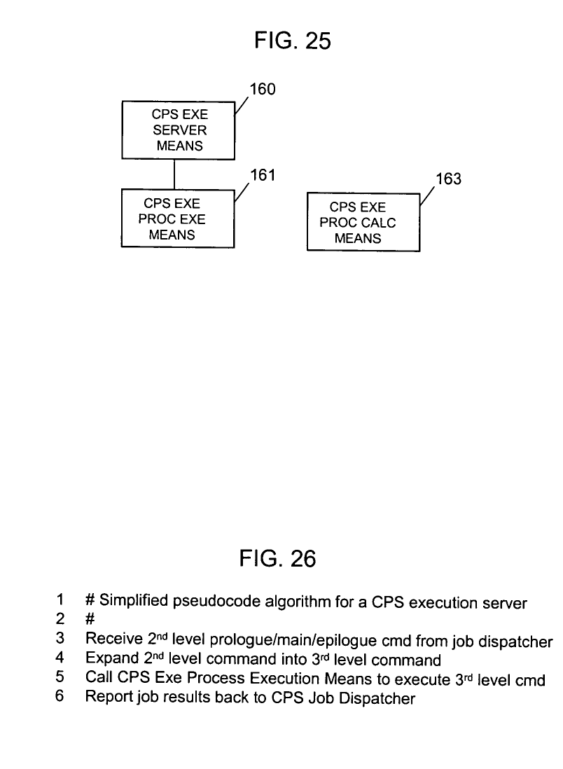

FIG. 25 shows a simplified architecture for a CPS Execution Server Means 160. This architecture does not support external job expansion.

Module CPS Execution Server Means 160 is responsible for receiving incoming individual prologue, main, and epilogue commands from CPS Job Dispatcher Means 142, and for expanding them into third-level commands, and for executing third-level commands to fulfill the intent of the original symbolic job request.

Module CPS Executable Process Execution Means 161 is responsible for managing the execution of third-level commands, using process-spawning techniques that are well known to those skilled in the programming arts.

Module CPS Executable Process Calculation Means 163 is an external program that provides services to the present CPS invention. It is responsible for calculating and generating an executable process representation such as a makefile, Perl script, or other executable script file. The generated file contains various third-level command sequences that are optimally customized to fit the current symbolic job request and the current collection.

CPS Execution Server Means 160 typically calls an external makefile generator program (or equivalent) such as CPS Executable Process Calculation Means 163 to generate a makefile or a Perl file that contains third-level commands that perform the “real” computational work required by the original symbolic job request.

Collection makefile generation is a very complex computational task, so the present CPS invention does not perform such calculations itself. Instead, in a preferred implementation of a CPS system, collection makefile generation is a function that is performed by an external Collection Makefile Generator program (or equivalent). See the list of related patent applications at the front of this document for more information on Collection Makefile Generators.

FIG. 26 shows a simplified algorithm for a CPS Execution Server Means 160.

In operation, CPS Execution Server Means 160 receives an individual second-level prologue, main, or epilogue command from CPS Job Dispatcher Means 142.

For each incoming command received, CPS Execution Server Means 160 expands the second-level command into a sequence of third-level executable commands. (The expansion process is described in detail later in this document.)

To execute third-level commands, CPS Execution Server 160 calls helper module CPS Executable Process Execution Means 161 to perform the execution using common process spawning techniques that are well known to those skilled in the programming arts.

If the incoming command requests calculation of an executable process description such as a makefile, CPS Executable Process Execution Means 161 calls an external program such as CPS Executable Process Calculation Means 163 to generate the desired executable process description. See the list of related patent applications at the front of this document for more information on a Collection Makefile Generator, which is one possible implementation of CPS Executable Process Calculation Means 163.

Those skilled in the art will appreciate that the architectures shown above cleanly separate commands into three abstraction levels (the symbolic task level, the process management level, and the makefile “do the real work” level). In addition, the architecture clearly puts responsibility for detailed executable process calculations on an external makefile generator program (or equivalent).

Now that readers are familiar with the overall architecture and functions of the present Collection Processing System invention—including collections, collection storage systems and namespaces, collection references, shortcut references, symbolic job requests, internal symbolic job expansions, job dispatching, three levels of command abstraction, external makefile generation, and command execution on execution servers—we can dig deeper into the inventive structures and methods of a preferred CPS implementation.

Collection Processing System Architecture #3

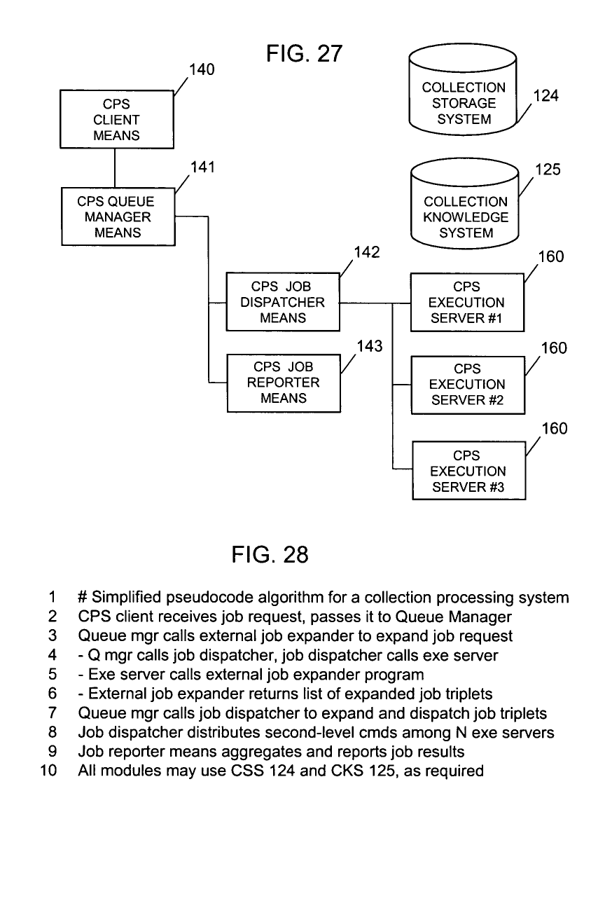

FIG. 27 shows a simplified architecture for a preferred CPS system that performs symbolic job expansion using an external support program. The architecture in FIG. 27 is identical to the architecture of FIG. 23, except that FIG. 27 does NOT have a module CPS Symbolic Job Expander Means 150.

FIG. 28 shows a simplified algorithm for the CPS system of FIG. 27. Except for delegating symbolic job expansion to an external program called by a CPS Execution Server Means 160 FIG. 28 Lines 3-6, the algorithm of FIG. 28 is identical to the algorithm of FIG. 24.

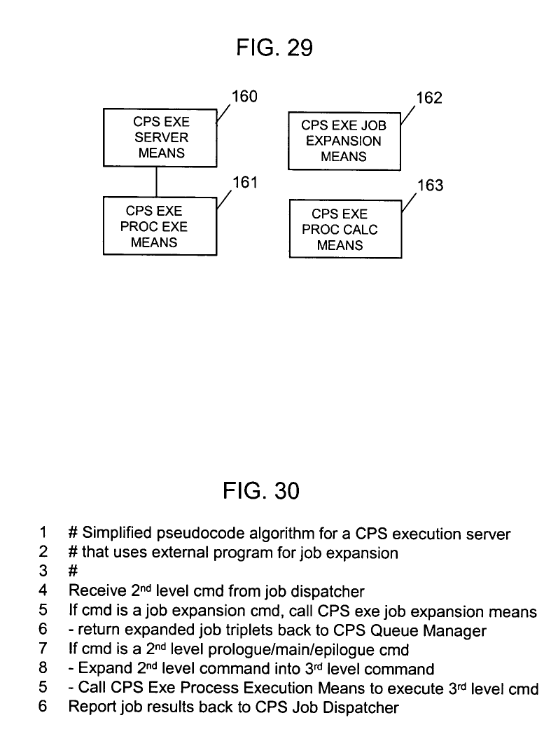

FIG. 29 shows a simplified architecture for a CPS Execution Server Means 160 that performs symbolic job expansion by calling an external program module CPS Execution Job Expansion Means 162. In all other respects, the CPS Execution Server Means 160 shown in FIG. 29 is identical to the CPS Execution Server of FIG. 25.

FIG. 30 shows a simplified algorithm for the CPS Execution Server Means 160 of FIG. 29. Except for performing symbolic job expansion using an external program FIG. 30 Lines 5-6, called by CPS Execution Server Means 160, the algorithm of FIG. 30 is identical to the algorithm of FIG. 26.

Internal Versus External Job Expansion

There is no theoretical difference between internal and external symbolic job expansion, as far as module functions, data inputs, or data outputs are concerned.

However, our implementation experience has shown that CPS architectures that use external job expansion programs have a practical performance advantage over architectures that use internal job expansion modules.

The main advantage of using external job expansion methods is that the computational load of symbolic job expansions can be shifted off of the computer doing central CPS queue management work and on to a remote CPS execution server. This is a useful and practical thing to do because CPS queue manager computers typically get very busy as CPS system load increases.

Those skilled in the programming arts will immediately appreciate that using external job expansion is a software reaction to inadequate hardware resources on the central CPS queue management computer. But those skilled in the art will also appreciate that treating job expansion as “just another external CPS job to run” simplifies the design and implementation of the CPS system by moving job expansion responsibilities out of the CPS system itself and into an external standalone program. Finally, those skilled in the art will recognize that the preferred implementation presented here is only our particular resolution of this issue. Other implementations could legitimately tradeoff implementation and performance factors in other ways, leading to different, but functionally equivalent architectures.

A significant amount of computational work is involved in job expansion actions because of the need to repeatedly contact both Collection Storage Systems 124 and Collection Knowledge Systems 125 to obtain job expansion information. For example, a symbolic job request may easily require a CPS system to request expansion information for thousands of collections. These same thousands of collections, if involved in typical multiplatform software build operations that used 10 or 20 computing platforms, would typically require CPS Queue Manager Means 141 to manage job triplets for hundreds of thousands of expanded jobs. Those skilled in the art will recognize that the scale of these responsibilities (managing hundreds of thousands of jobs) is a good reason to reduce the computational load on the central CPS queue manager computer, and to spread job expansion loads over multiple CPS execution server computers.

Collection Processing System Modules

FIG. 27 shows a simplified architecture for a CPS system that uses external job expansion and external makefile generation.

FIG. 27 is a preferred CPS system architecture because it uses external job expansion and external makefile generation.

All of the modules in FIG. 27 are identical to the modules described previously in FIG. 23, so they will not be described again in this section.

The main difference between the two architectures in FIG. 23 and FIG. 27 is that FIG. 23 uses internal job expansion and FIG. 27 uses external job expansion.

Collection Processing System Algorithm #3

FIG. 28 shows a simplified algorithm for the preferred CPS system of FIG. 27.

Since FIG. 27 shows a preferred CPS architecture, its algorithm will be discussed in detail, including dispatching of job triplets and symbolic task name expansion.

Incoming Symbolic Job Requests

FIG. 28 is the starting point for the following discussion.

In operation, module CPS Client Means 140 obtains a symbolic job request from a request originator (either a person or a program), and forwards it to CPS Queue Manager Means 141 for expansion and execution. FIG. 12 shows several example symbolic job requests.

Module CPS Client Means 140 is part of a typical client-server software system, and typically runs on a different computer than does CPS Queue Manager Means 141. Those skilled in the art will be familiar with the typical client-server implementation techniques used in these two modules.

Module CPS Queue Manager Means 141 receives incoming symbolic job requests from CPS Client Means 140 programs, and queues the symbolic job requests in a typical software queue pending expansion and execution. Module CPS Queue Manager Means 141 is implemented using standard client-server programming and software queuing techniques well known to those skilled in the programming arts.

Incoming symbolic job requests (and expanded job triplet job requests) are all queued on the same job priority queue. Various queue priority strategies are possible for managing job priority and position in the queue, such as first-in-first-out, high priority first, or priority determined by user identity. In our preferred CPS implementation, a simple first-in-first-out job priority strategy was used. Other implementations could legitimately use other strategies.

Server Architecture for External Job Expansion

FIG. 29 shows a simplified architecture for a CPS Execution Server Means 160 that uses an external job expansion program and an external makefile generator program. Module CPS Execution Server Means 160 is responsible for receiving incoming individual second-level commands from CPS Job Dispatcher Means 142, and executing them to fulfill the intent of the original symbolic job request. Incoming second-level commands can be job expansion requests, or can be typical prologue/main/epilogue commands.

Module CPS Executable Process Execution Means 161 is responsible for managing the execution of individual job expansion or prologue, main, and epilogue commands, using process-spawning techniques that are well known to those skilled in the programming arts.

Module CPS Execution Job Expansion Means 162 is an external program that performs symbolic job expansion of collection references and returns a list of expanded job triplets for expansion results.

See the list of related patent applications at the front of this document for more information on a preferred implementation of a Collection Symbolic Job Expander.

Module CPS Executable Process Calculation Means 163 is an external program that generates an executable process description such as a makefile or executable script. Generating makefiles is complex procedure that is beyond the scope of the present invention, so an external program is called to do the required job.

See the list of related patent applications at the front of this document for more information on a preferred implementation of a Collection Makefile Generator.

Algorithm External Job Expansion

FIG. 30 shows a simplified algorithm for a CPS Execution Server Means 160 that uses an external CPS Executable Job Expansion Means 162.

In operation, when a symbolic job request reaches the front of the job queue, CPS Queue Manager Means 141 must expand the symbolic job into a list of smaller job triplets FIG. 19, so that the job triplets can be assigned to execution servers for execution.

To initiate a job expansion action in a preferred CPS implementation that uses external job expansion, CPS Queue Manager Means 141 expands the symbolic job request at the front of the queue by issuing a job triplet expansion request. The job triplet expansion request is not special in any way, other than the fact that it is generated by the CPS system itself to force a symbolic job expansion action.

The job expansion request is passed through a CPS Job Dispatcher Means 142 and a CPS Execution Server Means 160 to an external program CPS Execution Job Expansion Means 162, which performs the job expansion action.

CPS Execution Job Expansion Means 162 calculates expanded job triplets and sends them back to CPS Queue Manager Means 141 for queuing on the main job queue.

Queuing Expanded Job Triplets

It is a design goal of the present CPS invention to give incoming expanded job triplets the same priority on the job queue as was held by the original symbolic job request. Otherwise, to give them a different priority would defeat normal queue management policies by giving job triplets a lower queue priority than their original symbolic job request parent. (Note that only lower priorities are possible, since the parent symbolic job request was at the front of the queue when job expansion was initiated.)

To facilitate queuing the expanded job triplets into the same job priority position in the queue, CPS Queue Manager Means 141 records the current queue priority of the symbolic job request into the job expansion request. When CPS Execution Job Expansion Means 162 sends expanded job triplets back to CPS Queue Manager Means 141 for queuing, it also sends back the original queue priority of the original symbolic job request. CPS Queue Manager Means 141 uses that priority value to queue incoming job triplets into proper queue position (at the front), and removes the original symbolic job request from the job queue.

Incoming job triplets each contain a particular visit order value, as shown in FIG. 19 Column 3. Visit order values ensure that proper processing dependencies are followed as successive job triplets are executed. These visit order values do not affect the queue position of job triplets with respect to other symbolic job requests, because incoming job triplets are queued as a group, replacing their original parent symbolic job request. Job triplet visit order values affect only the queue priority of a job triplet within an expanded job triplet group.

At this point in operation, the original symbolic job request (such as shown in FIG. 12) has been replaced with a list (a group) of expanded job triplets (such as shown in FIG. 19) on the job queue. Recall that the symbolic task name from each original symbolic job request is always associated with each job triplet derived from that request, as is shown by the data structure in FIG. 20 Line 3. This association enables a CPS system to apply the original symbolic task operation to each job triplet derived from the original symbolic job request.

Next, we explain how expanded job triplets are dispatched and expanded for execution.

Dispatching a Job Triplet

The process of dispatching a job triplet for execution proceeds in two major steps.

First, the symbolic task name in the triplet is expanded into a sequence of second-level, process-oriented, platform-independent commands called “task parts.” These are the second-level prologue/main/epilogue commands that have been mentioned previously.

Second, the sequence of platform-independent task parts is expanded into third-level executable commands that can be executed by a CPS Execution Server Means 160.

In what follows, we treat the two steps in their natural order.

Symbolic Task Name Expansion

Recall that first-level symbolic job requests contain a symbolic task name, as shown in FIG. 12 Line 5 and Line 12. In the example of Line 5, the symbolic task name is “rebuild,” which is a user-defined symbolic task name that means “checkout and rebuild a collection.” For example, “rebuild” would checkout, recompile, and link files in a C program collection.

Recall also that the original symbolic task name is later associated with each job triplet produced by a job expansion action, as shown by the data structure of FIG. 20 Line 3. The original symbolic task name must be applied to all collections produced by a job expansion action, in order to carry out the intent of the original symbolic job request.

Task name expansion converts a first-level task name to a sequence of second-level, process-oriented, platform-independent “task part” commands that are passed to a CPS Execution Server Means 160 for further expansion and execution.

Task name expansion is accomplished with task name tables, and task name definition files, as the following sections will show.

Syntax of Task Definition Files

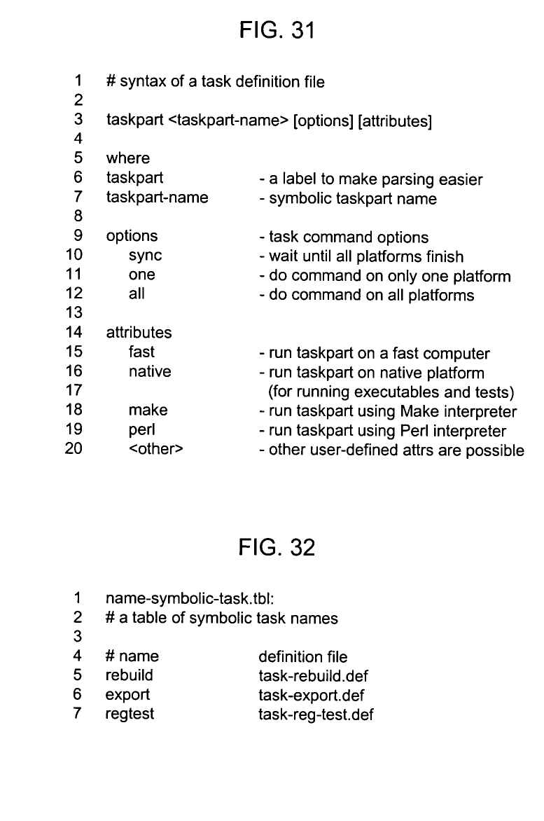

FIG. 31 shows the syntax of a task definition file that defines the meaning of a symbolic task name such as “rebuild.”

A task definition file is a sequence of task part statements. Each task part statement has four parts, as shown by FIG. 31 Line 3.

The first part FIG. 31 Line 6 is a fixed token “taskpart” that makes parsing the file easier for programs.

The second part FIG. 31 Line 7 is a user-defined name of a task part.

The third part FIG. 31 Lines 9-12 is an option string that can be the value “one” or “sync.”

The option “one” means that the task part should only be executed on one computing platform, to avoid conflicts caused by multiple platforms executing the same task part. (The default system behavior is to execute each task part on all computing platforms, which can sometimes cause file access collisions when multiple computers try to copy to the same filename.)

The option “sync” means that all platforms must wait for all other platforms to finish all task parts in the task definition file that occur before a “sync,” before any platform can proceed with its next task part. This forces all platforms to wait for all other platforms to complete a particular task part before any platform can proceed to the next task part. For example, sync operations are useful for holding all platforms back while one platform executes a “one” task part.

The fourth part FIG. 31 Lines 14-19 is sequence of task part attributes that help a CPS Job Dispatcher Means 142 match task parts to various CPS Execution Server Means 160. For example, a “fast” task part attribute encourages a job dispatcher to put a task part on a fast computer. As a second example, a “make” attribute tells execution servers that a task part should be executed by a Make program, using a makefile.

Now that we have shown the syntax of task definition files, we continue with an explanation of symbolic task name expansion.

Task Name Tables and Task Definition Files

FIG. 32 shows a simplified symbolic task name table. Column 1 contains user-defined symbolic task names, and Column 2 contains corresponding task definition filenames. To expand a task name, a CPS Job Dispatcher Means 142 looks up a task name such as “rebuild” in FIG. 32 Line 5 Column 1 of a task name table to obtain from Line 5 Column 2 the name of a task definition file “task-rebuild.def.”

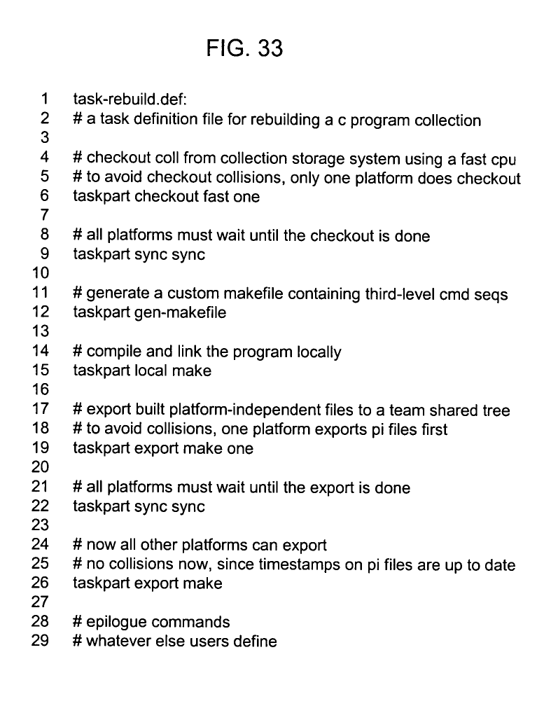

FIG. 33 shows an example task definition file for a “rebuild” symbolic task name. Recall that the goal of a “rebuild” task was to checkout and rebuild the contents of a collection. In the case of a C program collection, a rebuild task would need to checkout the collection, generate a makefile, recompile all source files, and link the object files to produce an executable binary from the collection. This is what the task parts in FIG. 33 accomplish.

Line 6 shows a task part that requests a checkout operation on a fast computer. Furthermore, only one computer should do the checkout operation, so that checkout collisions do not occur.

Line 9 tells all other platforms to wait until the checkout operation of Line 6 is completed before they start generating makefiles and rebuilding for their own platforms. Waiting is required because all files must be checked out in order to calculate a proper makefile, which is the next step. Once the platform performing the checkout of Line 6 is completed, “sync” conditions will be fulfilled, and all platforms can continue with the next task part.

Line 12 tells all platforms to generate a custom makefile for their own platform.

Line 15 tells all platforms to run a “make local” command once they have completed their makefile generation task part. There is no need for all platforms to wait for all platforms to finish generating makefiles. Instead, each platform can start compiling with “make local” as soon as a makefile has been generated for that platform.

Line 19 tells one platform to perform a “make export” operation to export rebuilt files to a shared location within a filesystem. The “one” attribute restricts the exporting action to one platform, to avoid file-copying collisions that might occur if multiple platforms try to export (copy) the same platform-independent file to the same location. Platform-independent files are typically processed and shared by all platforms, so it is possible for multiple platforms to collide when they try to work on the same platform-independent file.

By permitting only one computer to export its files first, the timestamps on newly exported platform-independent files will be newer than the timestamps for the original platform-independent files when other platforms try to export the original files (because the files have already been exported by the first platform.) This way, other platforms will see that it is not necessary for them to export another copy of the original platform-independent files, and so no collisions will occur.

Line 22 tells all other platforms to wait until the first platform completes its export operation, to avoid export (copy) collisions on platform-independent files.

Line 26 tells all other platforms to perform their export operations using a “make export” operation, timestamps permitting. Since timestamps for platform-independent files in the exported-to location are newer than corresponding timestamps in the source location, platform-independent files will not be exported again, thereby avoiding export collisions.

Line 29 is a placeholder comment that shows where users might put other epilogue commands in this task definition file, if they so desired.

This concludes discussion of how a first-level symbolic task name is expanded into a sequence of second-level, process-oriented, platform-independent task part statements. The next section begins a description of how second-level task part statements are expanded into executable third-level commands.

String Substitution in Task Part Definitions

Those skilled in the art know that it is common practice to use macros or variables within makefiles and other executable script languages. Variables are used to represent values that are used frequently, or as placeholders that can take on different values. Variables are also useful in third-level executable command sequences that carry out the processing required by second-level task parts.

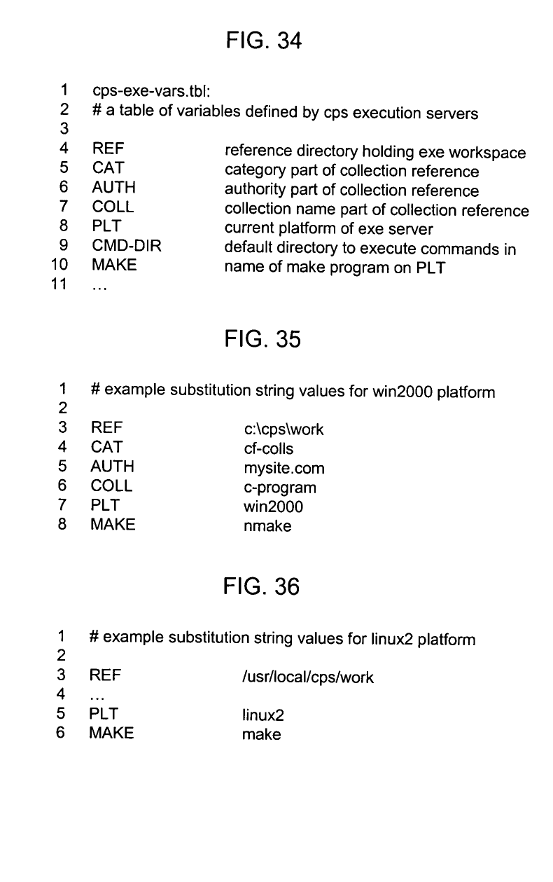

FIG. 34 shows a table of variables used by a CPS Execution Server Means 160. Variables in this table are a sample of variables that could be defined in a preferred implementation. The set of variables used is very dependent upon the tasks that users might want to define for their own symbolic tasks and computing requirements.

FIG. 35 shows an example of variable values for a “win2000” computing platform. Line 3 shows a platform-dependent pathname value. Line 7 shows a platform-dependent computing platform name string that identifies a computing platform. Line 8 shows a platform-dependent program name. CPS execution servers set these variable values so the values can be used in task part definition files by referencing the variable names.

FIG. 36 shows an example of variable values for a “linux2” computing platform. Lines 3, 7, and 8 show different platform-dependent values than the corresponding lines in FIG. 35. CPS execution servers set these variable values so the values can be easily accessed in task part definition files by referencing the variable names.

Having described task expansion from a first-level symbolic task name to a sequence of second-level task part statements, we now describe expansion of second-level task part statements into third-level executable commands.

Task Part Definitions

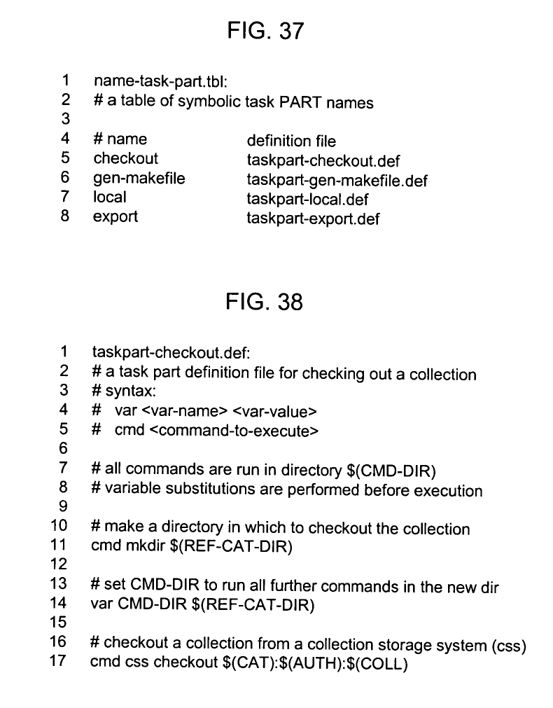

FIG. 37 shows an example task part name table. Column 1 shows task part names, and Column 2 shows corresponding task part definition filenames.

In operation, a CPS Execution Server Means 160 receives a second-level task part statement (“do this”) and a corresponding job triplet (“to that”). The execution server must expand the task part statement into a sequence of third-level executable commands, and apply them to the collection named in the job triplet.

To expand a task part name, a CPS Execution Server Means 160 looks up the task part name in a task part name table FIG. 37, to obtain a corresponding task part definition filename. Using the sequence of task parts for the “rebuild” task shown in FIG. 33, we begin with FIG. 33 Line 6, the checkout operation.

CPS Execution Server Means 160 looks up task part name “checkout” in the task part name table FIG. 37 Line 5 Column 1, to obtain task part definition filename “taskpart-checkout.def” from Column 2.

FIG. 38 shows an example task part definition file for a checkout operation, corresponding to the filename “taskpart-checkout.def” from FIG. 37 Line 5 Column 2.

The syntax of task part definition files is simple, being comprised of only two types of statements: VAR statements and CMD statements.

VAR statements FIG. 38 Line 4, Line 14 allow users to define their own variables and values in task part definition files, in case a generic set of variables for all task part definitions such as shown in FIG. 34 is inadequate for a particular task part definition.

CMD statements FIG. 38 Line 5, Line 11, Line 17 allow users to define particular third-level executable commands that carry out the computational goal of a corresponding second-level task part name.

FIG. 38 shows three commands that carry out a checkout operation. Line 11 ensures that an appropriately named working directory is available for the checkout operation, creating the directory if need be. Line 14 tells CPS Execution Server Means 160 to execute all commands in the new directory, by redefining the value of CMD-DIR, the default command execution directory. Line 17 performs the actual checkout operation, using an external Collection Storage System Means 124.

Those skilled in the programming arts will appreciate that the present CPS invention cleanly separates the three levels of command abstraction mentioned previously. People and CPS clients use first-level symbolic task names. CPS job dispatchers use second-level task definitions and task part statements. CPS execution servers use third-level task part definition commands.

Note that there must be a correspondence between (1) second-level task part names used in task part definitions seen by a CPS Job Dispatcher Means 142, such as FIG. 33 Line 6 “checkout” and (2) entries in a task part definition name table used by a CPS Execution Server Means 160, such as shown in FIG. 37 Line 5. If incoming task part names are not found in a task part definition name table such as FIG. 37, task part names are considered invalid, and will cause job processing errors.

Makefile Generation

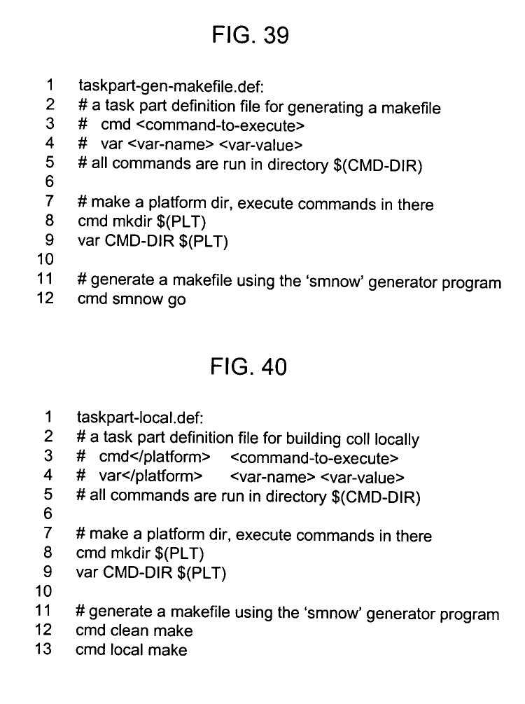

FIG. 39 shows an example task part definition file for generating a makefile.

Line 8 ensures that a platform-dependent working directory is available, and creates one if necessary.

Line 9 specifies that further third-level commands should be executed in the new platform directory, by redefining the CMD-DIR variable used by CPS Execution Server Means 160 to execute third-level commands.

Line 12 generates a custom makefile for the current collection and computing platform.

Once prologue commands have checked out a collection and generated a makefile, the main processing required by the original symbolic job request can begin.

Executing Makefile Commands

FIG. 40 shows an example task part definition file for building a C program collection.

Line 8 ensures that a platform-dependent working directory is available, and creates one if necessary.

Line 9 specifies that further third-level commands should be executed in the new platform directory, by redefining the CMD-DIR variable used by CPS Execution Server Means 160 to execute third-level commands.

Line 12 specifies that a CPS Execution Server Means 160 should run a “make clean” command in the platform directory of the current collection. Those skilled in the art will recognize “make clean” as a popular makefile command for cleaning up the current working directory by deleting old object files, executables, and other intermediate files, in preparation for a fresh build operation.

Line 13 specifies that a CPS Execution Server Means 160 should run a “make local” command in the platform directory of the current collection. Those skilled in the art will recognize “make local” as a popular makefile command for performing all compilations and linking operations necessary to build executable programs from a tree of source files.

This concludes our explanation of symbolic task name expansion in a preferred implementation of the present Collection Processing System CPS invention.

Summary of Do This To That

Recall that it was a design goal of the present CPS invention to provide people with a convenient means for performing complex computational operations on collections using a simple, two-part “do this (symbolic task) to that (collection reference)” syntax.

Symbolic job requests were a means for providing a “do this to that” syntax.

Part 1 of a symbolic job request was a first-level, user-defined, symbolic task name. We have described means for expanding first-level symbolic task names in symbolic job requests into second-level task part statements, and means for expanding second-level task part statements into third-level executable commands. CPS execution servers execute third-level executable commands using child process spawning techniques that are well known to the art.

Part 2 of a symbolic job request was a collection reference. We have described collections, collection storage systems, managed collection namespaces, collection references, and collection reference expansion into job triplets containing a particular collection name, computing platform, and visit order ranking to ensure proper dependency orders during collection processing operations.

Further, we have described means for performing external job expansion (collection reference expansion), and for external makefile generation.

Together, these inventive structures and methods comprise a preferred implementation of the present Collection Processing System, which enables people to perform complex operations on large sets of collections in a convenient, multiplatform, scalable way that was not previously possible using prior art techniques.

Conclusion

The present Collection Processing System invention has many practical applications in the technological arts. For example, it can carry out complex multiplatform software build operations with essentially no human labor involved. It enables both people and programs to perform complex operations on large sets of collections using simple, convenient, symbolic job requests that were not possible using prior art techniques.

In particular, the present Collection Processing System invention frees people from the responsibility for providing—or even understanding—the many low-level processing details that are required to carry out distributed, multiplatform, parallel computations on collections.

The present CPS invention provides practical solutions to several important problems faced by people who perform operations on large sets of collections. The problems include: (1) the Collection Processing System Problem, (2) the Collection Job Expansion Problem, (3) the Collection Platform Assignment Problem, (4) the Collection Job Ordering Problem, (5) the Collection Job Scheduling Problem, (6) the Collection Executable Process Calculation Problem, (7) the Collection Process Execution Problem, and (8) the Platform Dependent Processing Task Problem.

The present Collection Processing System invention enables people and programs to perform advanced computational operations on collections in a distributed, multiplatform, fully automated way, using inventive structures and methods that were not previously known to the art.

Ramifications

Although the foregoing descriptions are specific, they should be considered as example embodiments of the invention, and not as limitations of the invention. Many other possible ramifications can be imagined within the teachings of the disclosures made here.

General Software Ramifications

The foregoing disclosure has recited particular combinations of program architecture, data structures, and algorithms to describe preferred embodiments. However, those of ordinary skill in the software art can appreciate that many other equivalent software embodiments are possible within the teachings of the present invention.

As one example, data structures have been described here as coherent single data structures for convenience of presentation. But information could also be spread across a different set of coherent data structures, or could be split into a plurality of smaller data structures for implementation convenience, without loss of purpose or functionality.

As a second example, particular software architectures have been presented here to strongly associate primary algorithmic functions with primary modules in the software architectures. However, because software is so flexible, many different associations of algorithmic functionality and module architectures are also possible, without loss of purpose or technical capability. At the under-modularized extreme, all algorithmic functionality could be contained in one big software module. At the over-modularized extreme, each tiny algorithmic function could be contained in a separate little software module. Program modules could be contained in one executable, or could be implemented in a distributed fashion using client-server architectures and N-tier application architectures, perhaps involving application servers and servlets of various kinds.

As a third example, particular simplified algorithms have been presented here to generally describe the primary algorithmic functions and operations of the invention. However, those skilled in the software art know that other equivalent algorithms are also easily possible. For example, if independent data items are being processed, the algorithmic order of nested loops can be changed, the order of functionally treating items can be changed, and so on.

Those skilled in the software art can appreciate that architectural, algorithmic, and resource tradeoffs are ubiquitous in the software art, and are typically resolved by particular implementation choices made for particular reasons that are important for each implementation at the time of its construction. The architectures, algorithms, and data structures presented in this disclosure comprise one such implementation, which was chosen to emphasize conceptual clarity.

From the above, it can be seen that there are many possible equivalent implementations of almost any software architecture or algorithm. Thus when considering algorithmic and functional equivalence, the essential inputs, outputs, associations, and applications of information that truly characterize an algorithm should be considered. These characteristics are much more fundamental to software inventions than are flexible architectures, simplified algorithms, or particular organizations of data structures.

Collection Knowledge System

The foregoing disclosure used simple text files to illustrate structured tables of information. However, other implementations are also possible.

For example, all software means for retrieving information from the simple text files shown here might also be implemented to retrieve information from a relational database, or from a Collection Knowledge System. See the related patent applications at the front of this document for more information on Collection Knowledge Systems.

Collection Storage Systems

The foregoing disclosure used a Collection Storage System to obtain information about collection types and explicit visit orders in order to expand collection references from a symbolic job request. However, other means for storing collections and retrieving information are also possible.

For example, a typical industry configuration management system could be used to store and retrieve collections, and collection specifier information (including collection type and visit order information) could be stored in a separate database facility.

In general, any means for retrieving collections and collection information is sufficient for a CPS system if a CPS system can obtain the information through a programmatic interface.

Job Expansion Means

The foregoing disclosure used an external support program to expand collection references within symbolic job requests into lists of job triplets that contained individual collection names, platform names, and processing dependency visit orders. However, other means for accomplishing these data requirements are also possible.

For example, job expansion could be performed internally, if an implementation was willing to accept the additional complexity and performance requirements. Job expansion could also be performed in multiple separate steps, either internally or externally.

As another example, if an implementation only worked with a single platform, platform expansions could be omitted, and job triplets could become job doublets. Similarly, if all collections being worked on were independent of each other, there would be no need for processing order dependency information such as visit orders in the job triplets.

Those skilled in the art can recognize that if only independent, individual collections were being processed on one platform, there would be no need for job expansions at all. However, these conditions are not very general, and so would have limited practicality in typical software environments.

Process Calculation Means

The foregoing disclosure used an external support program to generate makefiles containing third-level executable commands. An external program is preferred because custom makefile generation is a complex computation that is best treated in a separate program. (For example, see the list of related patent applications at the front of this document for more information on Collection Makefile Generators.) However, other means of calculating executable processes are also possible.

For example, process calculation could be done internally to a CPS system, if additional implementation complexity was acceptable. Process calculations could also be done using different means other than makefiles, such as Perl scripts, Python scripts, or executable scripts in some other programming language. For example, we have achieved equivalent CPS results using a Perl-script generator that fulfills the function of a CPS Executable Process Calculation Means 163.

Indeed, there is no need for dynamic calculation of executable makefiles or process scripts at all, if appropriate predefined versions of these files could be retrieved from a database when they are needed, or if such makefiles or scripts were stored within a collection itself.

From the perspective of a CPS system, the means used to calculate an executable process is not material, so long as CPS execution servers can obtain and invoke a suitable executable process script through a programmatic interface.

Task Expansion Means

The foregoing disclosure used three levels of abstraction to convert first-level symbolic, user-defined task names into second-level, process-oriented task part statements, and then into third-level executable commands in task part definition files and executable makefiles. The three abstraction levels conveniently mapped on to CPS clients (first-level), CPS queue managers (second-level), and CPS execution servers (third-level). However, other means of task expansion are also possible.

For example, symbolic task names could be directly mapped into third-level executable commands, by omitting the inventive second-level data structures described in this document. However, it is likely that such an approach would lose the ability to share third-level command sequences among symbolic tasks, because multiple second-level statements would not exist to point at a shared third-level command sequence. In addition, some multiplatform flexibility might be lost, since no platform dependent information is typically encoded in a symbolic task name, yet third-level commands are fully platform dependent.

Another possible means would be to store task name expansions and executable command sequences in a database that could be queried to formulate an appropriate series of executable commands. This approach, in essence, is another means for dynamically calculating an executable process such as a makefile or script file. The main difference here is that command sequences are retrieved from a database, and may or may not be written out to a makefile or script file in tangible form. Commands could be retrieved from a database and then be executed, without ever being written to a disk file.

Practical Applications

The present Collection Storage System invention has many practical applications in the technical arts. For example, configuration management systems and automated software build systems could use the present Collection Processing System invention to enable people to conveniently perform arbitrary, user-defined computational operations on large sets of collections.

Scope

The full scope of the present invention should be determined by the accompanying claims and their legal equivalents, rather than from the examples given in the specification.

Readers are once again reminded to be careful not to confuse the intended meanings of special lexicographic terms such as “collection” in this application with the common dictionary meanings of such words.

Readers should be aware that much novel and inventive structure is introduced into the claims below by including special terms and inventive data structures such as “collection symbolic job request” and “collection reference expression” in claim clauses, where the special terms serve to narrow and limit the claims.

1. A Collection Processing System process for performing symbolic task operations on collections, to be performed on or with the aid of a computer, comprising the following steps:
(a) receiving a collection symbolic job request from a request originator to perform a collection processing operation on a collection reference expression,
(b) performing said collection processing operation on said collection reference using a collection processing system means, and
(c) returning results of said collection processing operation to said request originator,
wherein a collection symbolic job request is comprised of a symbolic task name and a collection reference expression, and wherein a collection is comprised of a collection specifier, including a collection type indicator, and optional collection contents,
thereby solving the Collection Processing System Problem and improving the productivity of people that perform complex computational tasks on large sets of collections.

2. The process of claim 1, wherein
(a) said step of performing said collection processing operation uses a collection symbolic job expander means for expanding said collection reference into a list of particular individual collections, to help fulfill the computational intent of said collection symbolic job request,
thereby solving the Collection Job Expansion Problem, and thereby improving human productivity by freeing people from the need to specify long lists of individual collections in collection processing requests.

3. The process of claim 1, wherein
(a) said step of performing said collection processing operation uses a collection symbolic job expander means for expanding said collection reference into a list of job triplets each comprised of an individual collection name, a computing platform name, and a processing dependency visit order value, to help fulfill the computational intent of said collection symbolic job request,
thereby solving the Collection Platform Assignment Problem, solving the Collection Job Ordering Problem, and thereby improving human productivity by freeing people from the need to specify long lists of individual collections, computing platforms, and visit order values in collection processing requests.

4. The process of claim 1, wherein
(a) said step of performing said collection processing operation uses a collection processing system job dispatcher means for maintaining a proper execution ordering among collection symbolic job requests and lists of expanded job triplets, to help fulfill the computational intent of said collection symbolic job request,
thereby solving the Collection Job Scheduling Problem, and thereby improving human productivity by freeing people from the need to manually determine and control proper execution order among job triplets derived from collection reference expressions.

5. The process of claim 1, wherein
(a) said step of performing said collection processing operation uses a collection processing system job dispatcher means for expanding a first-level symbolic task name into a sequence of second-level task part statements that represent the computational intent of said collection symbolic job request,
thereby helping to solve the Collection Process Execution Problem, and thereby improving human productivity by freeing people from the need to manually determine, manage, and execute particular computer commands to carry out the computational intent of said collection symbolic job request.

6. The process of claim 1, wherein
(a) said step of performing said collection processing operation uses a collection executable process calculation means for dynamically calculating a set of detailed executable commands that can help to fulfill the computational intent of said collection symbolic job request,
thereby solving the Collection Process Execution Problem, solving the Platform Dependent Processing Task Problem, and thereby improving human productivity by freeing people from the need to manually calculate detailed sequences of platform-dependent computer commands to carry out complex collection processing operations.

7. The process of claim 1, wherein
(a) said step of performing said collection processing operation uses a collection processing system executable process execution means to execute platform-dependent computing commands to fulfill the computational intent of said collection symbolic job request,
thereby helping to solve the Collection Process Execution Problem, and thereby improving human productivity by freeing people from the need to manually execute sequences of computer commands on multiple platforms to carry out the computational intent of said collection symbolic job request.

8. A programmable Collection Processing System device for performing symbolic task operations on collections, whose actions are directed by software executing a process comprising the following steps:
(a) receiving a collection symbolic job request from a request originator to perform a collection processing operation on a collection reference expression,
(b) performing said collection processing operation on said collection reference using a collection processing system means, and
(c) returning results of said collection processing operation to said request originator,
wherein a collection symbolic job request is comprised of a symbolic task name and a collection reference expression, and wherein a collection is comprised of a collection specifier, including a collection type indicator, and optional collection contents,
thereby solving the Collection Processing System Problem and improving the productivity of people that perform complex computational tasks on large sets of collections.

9. The programmable device of claim 8, wherein
(a) said step of performing said collection processing operation uses a collection symbolic job expander means for expanding said collection reference into a list of particular individual collections, to help fulfill the computational intent of said collection symbolic job request,
thereby solving the Collection Job Expansion Problem, and thereby improving human productivity by freeing people from the need to specify long lists of individual collections in collection processing requests.

10. The programmable device of claim 8, wherein
(a) said step of performing said collection processing operation uses a collection symbolic job expander means for expanding said collection reference into a list of job triplets each comprised of an individual collection name, a computing platform name, and a processing dependency visit order value, to help fulfill the computational intent of said collection symbolic job request,
thereby solving the Collection Platform Assignment Problem, solving the Collection Job Ordering Problem, and thereby improving human productivity by freeing people from the need to specify long lists of individual collections, computing platforms, and visit order values in collection processing requests.

11. The programmable device of claim 8, wherein
(a) said step of performing said collection processing operation uses a collection processing system job dispatcher means for maintaining a proper execution ordering among collection symbolic job requests and lists of expanded job triplets, to help fulfill the computational intent of said collection symbolic job request,
thereby solving the Collection Job Scheduling Problem, and thereby improving human productivity by freeing people from the need to manually determine and control proper execution order among job triplets derived from collection reference expressions.

12. The programmable device of claim 8, wherein
(a) said step of performing said collection processing operation uses a collection processing system job dispatcher means for expanding a first-level symbolic task name into a sequence of second-level task part statements that represent the computational intent of said collection symbolic job request,
thereby helping to solve the Collection Process Execution Problem, and thereby improving human productivity by freeing people from the need to manually determine, manage, and execute particular computer commands to carry out the computational intent of said collection symbolic job request.

13. The programmable device of claim 8, wherein
(a) said step of performing said collection processing operation uses a collection executable process calculation means for dynamically calculating a set of detailed executable commands that can help to fulfill the computational intent of said collection symbolic job request,
thereby solving the Collection Process Execution Problem, solving the Platform Dependent Processing Task Problem, and thereby improving human productivity by freeing people from the need to manually calculate detailed sequences of platform-dependent computer commands to carry out complex collection processing operations.

14. The programmable device of claim 8, wherein
(a) said step of performing said collection processing operation uses a collection processing system executable process execution means to execute platform-dependent computing commands to help fulfill the computational intent of said collection symbolic job request,
thereby helping to solve the Collection Process Execution Problem, and thereby improving human productivity by freeing people from the need to manually execute sequences of computer commands on multiple platforms to carry out the computational intent of said collection symbolic job request.

15. A computer readable memory, encoded with data representing a Collection Processing System computer program, that can be used to direct a computer when used by the computer, comprising:
(a) means for receiving a collection symbolic job request from a request originator to perform a collection processing operation on a collection reference expression,
(b) means for performing said collection processing operation on said collection reference using a collection processing system means, and
(c) means for returning results of said collection processing operation to said request originator,
wherein a collection symbolic job request is comprised of a symbolic task name and a collection reference expression, and wherein a collection is comprised of a collection specifier, including a collection type indicator, and optional collection contents,
thereby solving the Collection Processing System Problem and improving the productivity of people that perform complex computational tasks on large sets of collections.

16. The computer readable memory of claim 15, wherein
(a) said means for performing said collection processing operation uses a collection symbolic job expander means for expanding said collection reference into a list of particular individual collections, to help fulfill the computational intent of said collection symbolic job request,
thereby solving the Collection Job Expansion Problem, and thereby improving human productivity by freeing people from the need to specify long lists of individual collections in collection processing requests.

17. The computer readable memory of claim 15, wherein
(a) said means for performing said collection processing operation uses a collection symbolic job expander means for expanding said collection reference into a list of job triplets each comprised of an individual collection name, a computing platform name, and a processing dependency visit order value, to help fulfill the computational intent of said collection symbolic job request,
thereby solving the Collection Platform Assignment Problem, solving the Collection Job Ordering Problem, and thereby improving human productivity by freeing people from the need to specify long lists of individual collections, computing platforms, and visit order values in collection processing requests.

18. The computer readable memory of claim 15, wherein
(a) said means for performing said collection processing operation uses a collection processing system job dispatcher means for maintaining a proper execution ordering among collection symbolic job requests and lists of expanded job triplets, to help fulfill the computational intent of said collection symbolic job request,
thereby solving the Collection Job Scheduling Problem, and thereby improving human productivity by freeing people from the need to manually determine and control proper execution order among job triplets derived from collection reference expressions.

19. The computer readable memory of claim 15, wherein
(a) said means for performing said collection processing operation uses a collection processing system job dispatcher means for expanding a first-level symbolic task name into a sequence of second-level task part statements that represent the computational intent of said collection symbolic job request,
thereby helping to solve the Collection Process Execution Problem, and thereby improving human productivity by freeing people from the need to manually determine, manage, and execute particular computer commands to carry out the computational intent of said collection symbolic job request.

20. The computer readable memory of claim 15, wherein
(a) said means for performing said collection processing operation uses a collection executable process calculation means for dynamically calculating a set of detailed executable commands that can help to fulfill the computational intent of said collection symbolic job request,
thereby solving the Collection Process Execution Problem, solving the Platform Dependent Processing Task Problem, and thereby improving human productivity by freeing people from the need to manually calculate detailed sequences of platform-dependent computer commands to carry out complex collection processing operations.

21. The computer readable memory of claim 15, wherein
(a) said means for performing said collection processing operation uses a collection processing system executable process execution means to execute platform-dependent computing commands to help fulfill the computational intent of said collection symbolic job request,
thereby helping to solve the Collection Process Execution Problem, and thereby improving human productivity by freeing people from the need to manually execute sequences of computer commands on multiple platforms to carry out the computational intent of said collection symbolic job request.
